(19) United States
(12) Patent Application Publication
(10) Pub. No.: US 2026/0181703 A1
(43) Pub. Date: Jun. 25, 2026

(54) BEAM INDICATION AND PRACH CONFIGURATION FOR A CANDIDATE CELL IN L1 AND L2 MOBILITY

(71) Applicant: QUALCOMM Incorporated, San Diego, CA (US)

(72) Inventors: Fang YUAN, Beijing (CN); Yan ZHOU, San Diego, CA (US)

(21) Appl. No.: 19/127,405

(22) PCT Filed: Dec. 29, 2022
(86) PCT No.: PCT/CN2022/143153

§ 371 Date: May 5, 2025

(51) Int. Cl. H04W 74/0833; H04L 5/00

(52) U.S. Cl. CPC H04W 74/0833; H04L 5/0053

(57) ABSTRACT

Apparatuses and methods for beam indications and RACH configurations for candidate cells in L1/L2 mobility of UEs are described. An apparatus is configured to receive, from a serving cell, a switching command that indicates a switch associated with L1/L2 mobility of the apparatus from the serving cell to a candidate cell of a set of candidate cells associated with the L1/L2 mobility. The switching command is associated with at least one of a TCI for a beam or at least one RACH parameter for a BWP of the set of candidate cells. The apparatus is also configured to communicate with the candidate cell based on the at least one of the TCI for the beam or the at least one RACH parameter for the BWP.

### TECHNICAL FIELD

The present disclosure relates generally to communication systems, and more particularly, to wireless communications systems and user equipment mobility.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method and an apparatus are provided. The apparatus is configured to receive, from a serving cell, a switching command that indicates a switch associated with a layer-1 or layer-2 (L1/L2) mobility of the UE from the serving cell to a candidate cell of a set of candidate cells associated with the L1/L2 mobility of the UE, where the switching command is associated with at least one of (1) a transmission configuration indication (TCI) for a beam or (2) at least one random access channel (RACH) parameter for a bandwidth part (BWP) of the set of candidate cells. The apparatus is also configured to communicate with the candidate cell based on the at least one of the TCI for the beam or the at least one RACH parameter for the BWP.

In the aspect, the method includes receiving, from a serving cell, a switching command that indicates a switch associated with L1/L2 mobility of the UE from the serving cell to a candidate cell of a set of candidate cells associated with the L1/L2 mobility of the UE, where the switching command is associated with at least one of (1) a TCI for a beam or (2) at least one RACH parameter for a BWP of the set of candidate cells. The method also includes communicating with the candidate cell based on the at least one of the TCI for the beam or the at least one RACH parameter for the BWP.

In an aspect of the disclosure, a method and an apparatus are provided. The apparatus is configured to configure a switching command that indicates a switch associated with L1/L2 mobility for a UE to a candidate cell of a set of candidate cells associated with the L1/L2 mobility of the UE, where the switching command is associated with at least one of (1) a TCI for a beam or (2) at least one RACH parameter for a BWP of the set of candidate cells. The apparatus is also configured to transmit, for the UE, the switching command that indicates the switch associated with the L1/L2 mobility for the UE to the candidate cell.

In the aspect, the method includes configuring a switching command that indicates a switch associated with L1/L2 mobility for a UE to a candidate cell of a set of candidate cells associated with the L1/L2 mobility of the UE, where the switching command is associated with at least one of (1) a TCI for a beam or (2) at least one RACH parameter for a BWP of the set of candidate cells. The method also includes transmitting, for the UE, the switching command that indicates the switch associated with the L1/L2 mobility for the UE to the candidate cell.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example configuration in UE mobility, in accordance with various aspects of the present disclosure.

FIG. 5 is a call flow diagram for wireless communications, in accordance with various aspects of the present disclosure.

FIG. 6 is a diagram illustrating an example for beam pre-configuration in UE mobility, in accordance with various aspects of the present disclosure.

FIG. 7 is a diagram illustrating an example for random access channel (RACH) pre-configuration in UE mobility, in accordance with various aspects of the present disclosure.

FIG. 8 is a diagram illustrating an example configuration for beams and RACH in UE mobility, in accordance with various aspects of the present disclosure.

FIG. 9 is a flowchart of a method of wireless communication, in accordance with various aspects of the present disclosure.

FIG. 10 is a flowchart of a method of wireless communication, in accordance with various aspects of the present disclosure.

FIG. 11 is a flowchart of a method of wireless communication, in accordance with various aspects of the present disclosure.

FIG. 12 is a flowchart of a method of wireless communication, in accordance with various aspects of the present disclosure.

FIG. 13 is a diagram illustrating an example of a hardware implementation for an example apparatus and/or network entity.

FIG. 14 is a diagram illustrating an example of a hardware implementation for an example network entity.

FIG. 15 is a diagram illustrating an example of a hardware implementation for an example network entity.

### DETAILED DESCRIPTION

Wireless communication networks, such as an LTE network and/or a 5G NR network, may be designed for UE mobility. Such UE mobility may be layer-3 mobility that relies on relatively slow messaging and configuration of UEs for post-mobility communications. As an example, a UE may be initially served by a serving cell, which may include a 5G NR cell or “SCell,” a combination of 5G NR and legacy protocols and/or hardware (e.g., an “SpCell” implementation), while candidate cells (e.g., legacy cells, 5G NR cells, and/or the like) are available to the UE for L3 mobility. The UE may receive L3 mobility communications from the serving cell for a move via L3 mobility to one of the candidate cells as a new serving cell, and the UE then moves to the new serving cell and initiates its setup for communications therewith (e.g., configurations for beams, a transmission configuration indication (TCI), a random access channel (RACH), etc.).

However, as noted above, L3 mobility may be relatively slow, and may not enable pre-configurations for various communications associated with candidate cells for mobility. The aspects described herein provide for beam indications and RACH configurations for candidate cells in L1/L2 mobility of UEs that includes pre-configurations for beam and RACH implementations with candidate cells, which may be faster and more efficient than L3 mobility. For example, a UE may receive, from a serving cell, a switching command that indicates a switch associated with L1/L2 mobility of the UE from the serving cell to a candidate cell of a set of candidate cells. The switching command may be associated with a TCJ for a beam and/or a RACH parameter(s) for a BWP of the set of candidate cells. The UE may thus be pre-configured to communicate with the candidate cell, via L1/L2 mobility, based on the TCJ for the beam and/or the RACH parameter(s) for the BWP, which may reduce mobility latency.

Various aspects relate generally to inter-cell mobility of UEs. Some aspects more specifically relate to L1/L2 inter-cell mobility of UEs with pre-configurations for beams and RACHs of candidate cells. In some examples, beams may be pre-configured by a serving cell via radio resource control (RRC) signaling, a medium access control (MAC) control element (MAC-CE), and downlink control information (DCI), and/or via a switching command itself, while a RACH may be pre-configured through a RACH parameter(s) for a BWP of candidate cells via RRC signaling, including beam failure recovery configurations.

Particular aspects of the subject matter described in this disclosure can be implemented to realize one or more of the following potential advantages. In some examples, by pre-configuring beams and RACHs for candidate cells in L1/L2 mobility, the described techniques can be used to reduce mobility latency through fast application of configurations for candidate cells, dynamic switching mechanisms among candidate cells, L1 enhancements for inter-cell beam management, including L1 measurement and reporting, and beam indication, inter-frequency and intra-frequency scenarios, etc.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

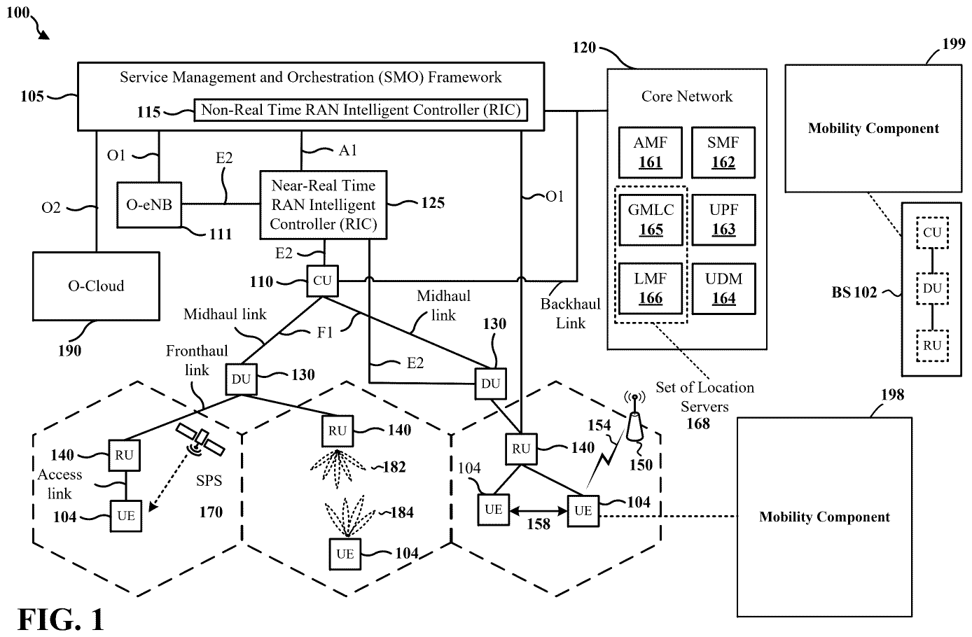

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit—User Plane (CU-UP)), control plane functionality (i.e., Central Unit—Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (0-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an AI interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as AI policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a mobility component 198 (“component 198”) that may be configured to receive, from a serving cell, a switching command that indicates a switch associated with L1/L2 mobility of the UE from the serving cell to a candidate cell of a set of candidate cells associated with the L1/L2 mobility of the UE, where the switching command is associated with at least one of (1) a TCI for a beam or (2) at least one RACH parameter for a BWP of the set of candidate cells. The component 198 is also configured to communicate with the candidate cell based on the at least one of the TCI for the beam or the at least one RACH parameter for the BWP. In aspects, the component 198 may be configured to receive, prior to receiving the switching command, at least one of a TCI configuration for the candidate cell or a RACH configuration for the candidate cell, where the TCI for the beam is based on the TCI configuration and the at least one RACH parameter is based on the RACH configuration. In aspects, the component 198 may be configured to receive the TCI for the beam from the serving cell via RRC signaling and prior to receiving the switching command, where the TCI for the beam includes at least one of: a first legacy TCI state for a periodic CSI-RS, first legacy spatial relation information for a periodic SRS or a PUCCH, or a list of legacy TCI states for a PDSCH. In aspects, the component 198 may be configured to receive an activation of the TCI for the beam via a MAC-CE that includes at least one of: a second legacy TCI state for a CORESET or a semi-persistent CSI-RS, second legacy spatial relation information for at least one of a semi-persistent SRS, an aperiodic SRS, or the PUCCH, a subset of legacy TCI states for the PDSCH, or a path loss RS for at least one SRS or at least one physical uplink shared channel PUSCH. In aspects, the component 198 may be configured to receive DCI that indicates a third legacy TCI state of the subset of the legacy TCI states for the PDSCH. In aspects, the component 198 may be configured to receive the TCI for the beam from the serving cell via RRC signaling and prior to receiving the switching command, where the TCI for the beam includes at least one of: a first unified TCI state for periodic CSI-RS or a periodic SRS that are configured not to follow unified TCI indications, or at least one of a list of downlink TCI states, a list of joint TCI states, or a list of uplink TCI states. In aspects, the component 198 may be configured to receive an activation of the TCI for the beam via a MAC-CE that includes a second unified TCI state for at least one of a CORESET, a semi-persistent CSI-RS, a semi-persistent SRS, or an aperiodic SRS, which are configured not to follow the unified TCI indications. In aspects, the component 198 may be configured to receive DCI that indicates at least one of: a joint TCI state for at least one of a PDSCH, a PDCCH, a PUSCH, a PUCCH, a CSI-RS, or a SRS, which are configured to follow the unified TCI indications, a downlink TCI state for at least one of the PDSCH, the PDCCH, or the CSI-RS, which are configured to follow the unified TCI indications, or an uplink TCI state for the PUSCH, the PUCCH, or the SRS, which are configured to follow the unified TCI indications. In aspects, the component 198 may be configured to receive, from the serving cell via the at least one transceiver and RRC signaling, the at least one RACH parameter for the BWP of the set of candidate cells, where the at least one RACH parameter includes at least one of (1) a PRACH parameter or (2) at least one BFR parameter. In certain aspects, the base station 102 may have a mobility component 199 (“component 199”) that may be configured to configure a switching command that indicates a switch associated with L1/L2 mobility for a UE to a candidate cell of a set of candidate cells associated with the L1/L2 mobility of the UE, where the switching command is associated with at least one of (1) a TCI for a beam or (2) at least one RACH parameter for a BWP of the set of candidate cells. The component 199 is also configured to transmit, for the UE, the switching command that indicates the switch associated with the L1/L2 mobility for the UE to the candidate cell. In aspects, the component 199 may be configured to transmit, for the UE and prior to transmitting the switching command, at least one of a TCI configuration for the candidate cell or a RACH configuration for the candidate cell, where the TCI for the beam is based on the TCI configuration and the at least one RACH parameter is based on the RACH configuration. In aspects, the component 199 may be configured to transmit, for the UE via RRC signaling and prior to transmitting the switching command, the TCI for the beam, where the TCI for the beam includes at least one of: a first legacy TCI state for a periodic CSI-RS, first legacy spatial relation information for a periodic SRS or a PUCCH, or a list of legacy TCI states for a PDSCH. In aspects, the component 199 may be configured to transmit, for the UE, an activation of the TCI for the beam via a MAC-CE that includes at least one of: a second legacy TCI state for a CORESET or a semi-persistent CSI-RS, second legacy spatial relation information for at least one of a semi-persistent SRS, an aperiodic SRS, or the PUCCH, a subset of legacy TCI states for the PDSCH, or a path loss RS for at least one SRS or at least one PUSCH. In aspects, the component 199 may be configured to transmit, for the UE, DCI that indicates a third legacy TCI state of the subset of the legacy TCI states for the PDSCH. In aspects, the component 199 may be configured to transmit, for the UE via RRC signaling and prior to receiving the switching command, the TCI for the beam, where the TCI for the beam includes at least one of: a first unified TCI state for periodic CSI-RS or a periodic SRS that are configured not to follow unified TCI indications, or at least one of a list of downlink TCI states, a list of joint TCI states, or a list of uplink TCI states. In aspects, the component 199 may be configured to transmit, for the UE, an activation of the TCI for the beam via a MAC-CE that includes a second unified TCI state for at least one of a CORESET, a semi-persistent CSI-RS, a semi-persistent SRS, or an aperiodic SRS, which are configured not to follow the unified TCI indications. In aspects, the component 199 may be configured to transmit, for the UE, DCI that indicates at least one of: a joint TCI state for at least one of a PDSCH, a PDCCH, a PUSCH, a PUCCH, a CSI-RS, or a SRS, which are configured to follow the unified TCI indications, a downlink TCI state for at least one of the PDSCH, the PDCCH, or the CSI-RS, which are configured to follow the unified TCI indications, or an uplink TCI state for the PUSCH, the PUCCH, or the SRS, which are configured to follow the unified TCI indications. In aspects, the component 199 may be configured to transmit, for the UE via the at least one transceiver and RRC signaling, the at least one RACH parameter for the BWP of the set of candidate cells, where the at least one RACH parameter includes at least one of (1) a PRACH parameter or (2) at least one BFR parameter. That is, aspects provide L1/L2 mobility for UEs with pre-configurations for beam TCI and RACH of candidate cells, dynamic mobility applications, and decreases in mobility latency.

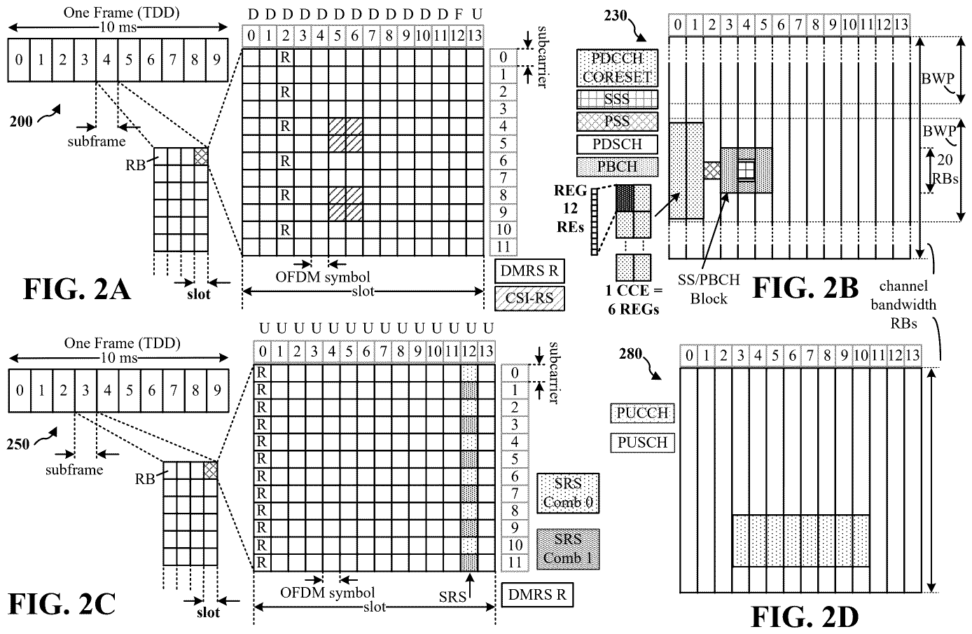

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | Cyclic |
|---|---|---|
| μ | Δf = 2^{μ} · 15 [kHz] | prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2 slots/subframe. The subcarrier spacing may be equal to 2^{μ}*15 kHz, where y is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 s. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

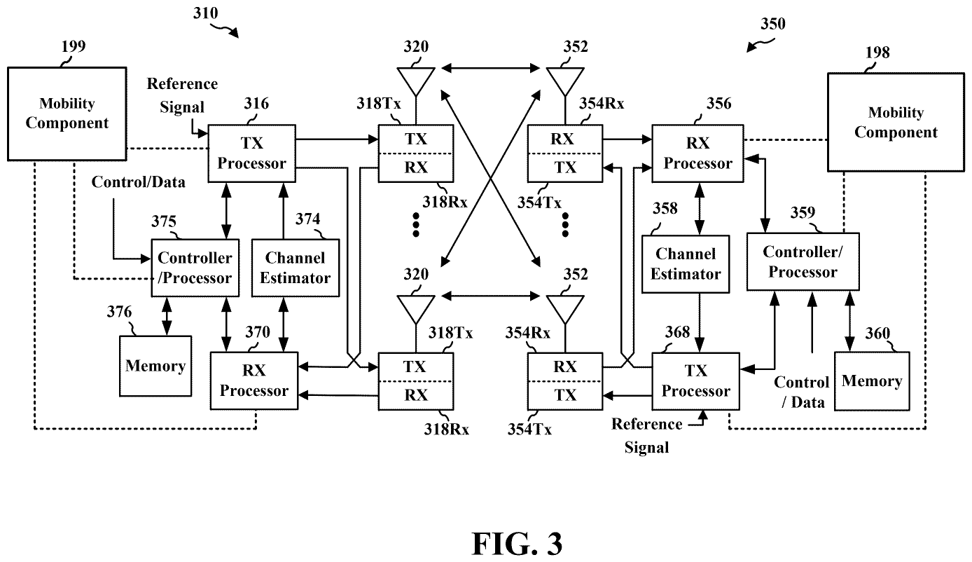

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a RRC layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the mobility component 198 of FIG. 1. At least one of the TX processor 316, the RX processor 370, and the controller/processor 375 may be configured to perform aspects in connection with the mobility component 199 of FIG. 1.

Wireless communication networks, such as an LTE network and/or a 5G NR network, may be designed for UE mobility. Such UE mobility may be layer-3 mobility that relies on relatively slow messaging and configuration of UEs for post-mobility communications. As an example, a UE may be initially served by a serving cell, which may include a 5G NR cell or “SCell,” a combination of 5G NR and legacy protocols and/or hardware (e.g., an “SpCell” implementation), while candidate cells (e.g., legacy cells, 5G NR cells, and/or the like) are available to the UE for L3 mobility. The UE may receive L3 mobility communications from the serving cell for a move via L3 mobility to one of the candidate cells as a new serving cell, and the UE then moves to the new serving cell and initiates its setup for communications therewith (e.g., configurations for beams, a transmission configuration indication (TCI), a random access channel (RACH), etc.).

However, as noted above, L3 mobility may be relatively slow, and may not enable pre-configurations for various communications associated with candidate cells for mobility. The aspects described herein provide for beam indications and RACH configurations for candidate cells in L1/L2 mobility of UEs that include pre-configurations of beams and RACH for candidate cells, which may be faster and more efficient than L3 mobility. That is, aspects provide for pre-configuration and maintenance of multiple candidate cells to allow fast application of configurations for the candidate cells and a target cell/new serving cell. For example, a UE may receive, from a serving cell, a switching command that indicates a switch associated with L1/L2 mobility of the UE from the serving cell to a candidate cell of a set of candidate cells. The switching command may be associated with a TCI for a beam and/or a RACH parameter(s) for a BWP of the set of candidate cells.

The UE may thus be pre-configured to communicate with the candidate cell, via L1/L2 mobility, based on the TCI for the beam and/or the RACH parameter(s) for the BWP, which may reduce mobility latency. The described techniques may reduce mobility latency through fast application of configurations for candidate cells, dynamic switching mechanisms among candidate cells via L1/L2 signaling (e.g., via mobility commands), L1 enhancements for inter-cell beam management, including L1 measurement and reporting, as well as beam indication, inter-frequency and intra-frequency scenarios, timing advance management, CU-DU interface signaling to further support L1/L2 mobility, FR2-specific enhancements, standalone, CA, and NR-DC scenario support for serving cell change within one configured grant (CG), intra-DU and intra-CU/inter-DU applicability, etc. Aspects may be applicable to intra-frequency and/or inter-frequency scenarios, as well as FR1 and/or FR2 implementations, and aspects include source and candidate/target cells being synchronized or non-synchronized.

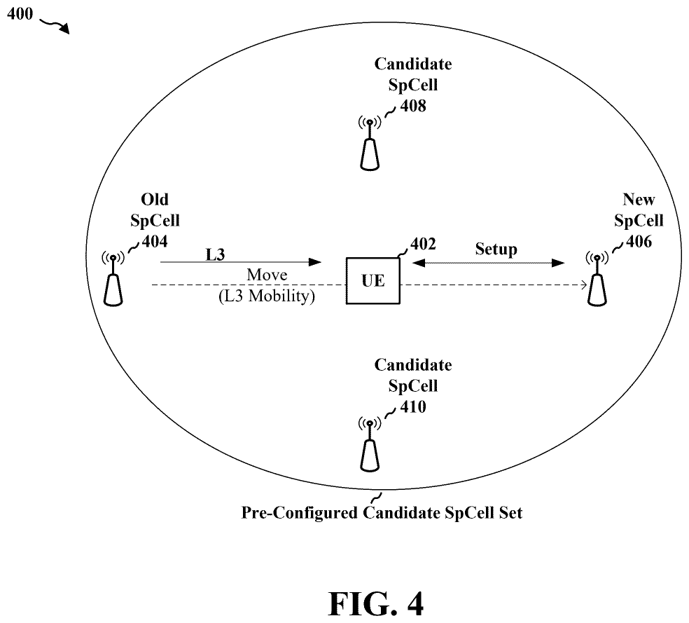

FIG. 4 is a diagram 400 illustrating an example configuration in UE mobility, in various aspects. In diagram 400, a UE 402 may be initially served by an SpCell 404, while three candidate cells (e.g., a pre-configured candidate SpCell set) are available to the UE 402 for L3 mobility: an SpCell 406, an SpCell 408, and an SpCell 410. After measurements performed by the UE 402 against the SpCells shown, the UE 402 may receive L3 mobility communications from SpCell 404 (e.g., a mobility command) for a move via L3 mobility to SpCell 406 as the new serving cell. The UE 402 then moves to the SpCell 406 and initiates its setup (e.g., configurations for beams, RACH, etc.) for communications with the SpCell 406.

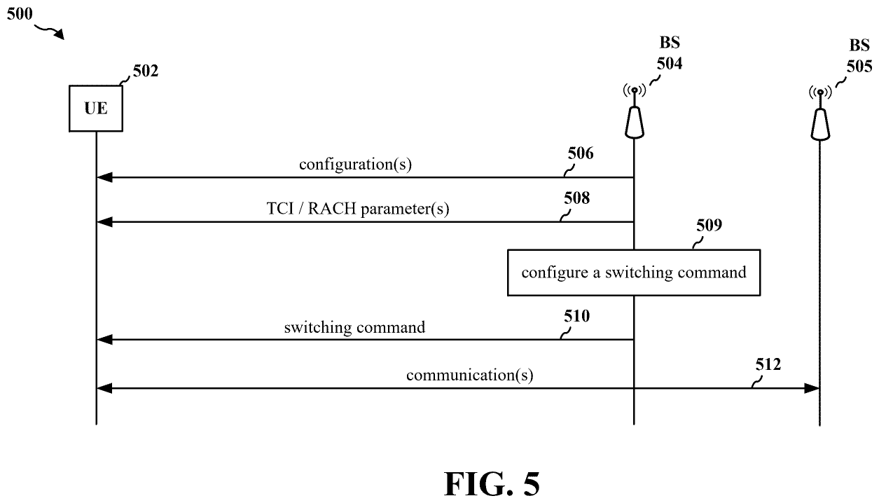

FIG. 5 is a call flow diagram 500 for wireless communications, in various aspects. Call flow diagram 500 illustrates beam indications and RACH pre-configurations for candidate cells in L1/L2 mobility at a wireless device (a UE 502, by way of example) for application at a serving cell such as a network node (a base station 504, such as a gNB or other type of base station, by way of example, as shown) and at a candidate cell such as a target network node a base station 505, such as a gNB or other type of base station, by way of example, as shown), in various aspects. Aspects described for the base station 504 may be performed by the base station in aggregated form and/or by one or more components of the base station in disaggregated form. Additionally, or alternatively, the aspects may be performed by the UE 502 autonomously, in addition to, and/or in lieu of, operations of the base station 504. The base station 504 may be configured to provide at least one cell, in aspects.

In the illustrated aspect, the UE 502 may be configured to receive a configuration(s) 506 provided from the base station 504. The configuration(s) 506 may include a TCI configuration for a candidate cell (e.g., the base station 505) and/or a RACH configuration for the candidate cell (e.g., the base station 505), where the TCI for the beam, as described herein, may be based on the TCI configuration and the at least one RACH parameter, as described herein, may be based on the RACH configuration. In aspects, the configuration(s) 506 may include a single signaling or multiple signaling, and the configuration(s) 506 may be provided by the base station 504 via RRC signaling. As described in further detail below, the configuration(s) 506 may be based on prior L1 measurements of a set of candidate cells (e.g., including the base station 505) performed by the UE 502.

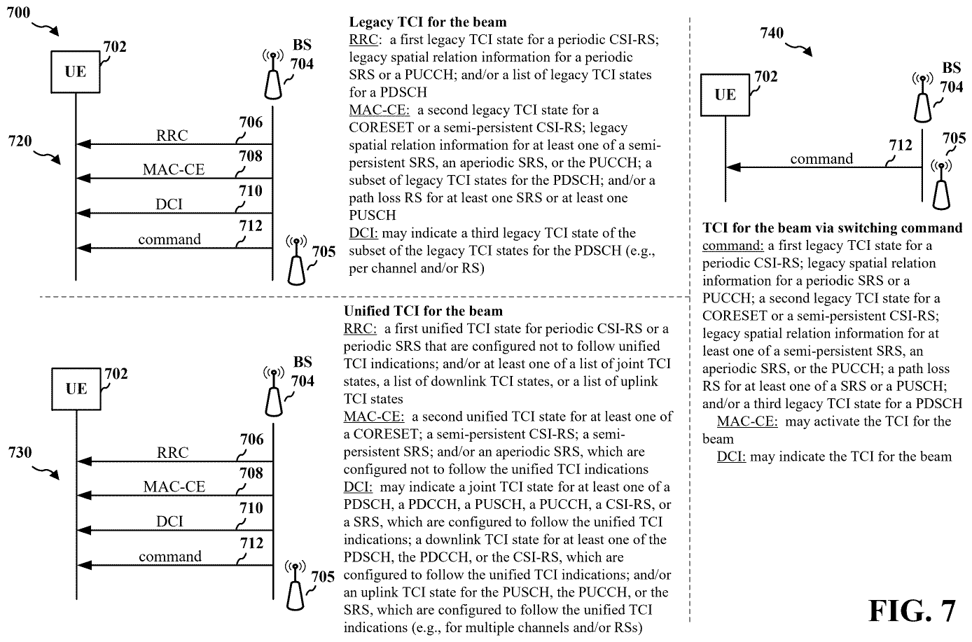

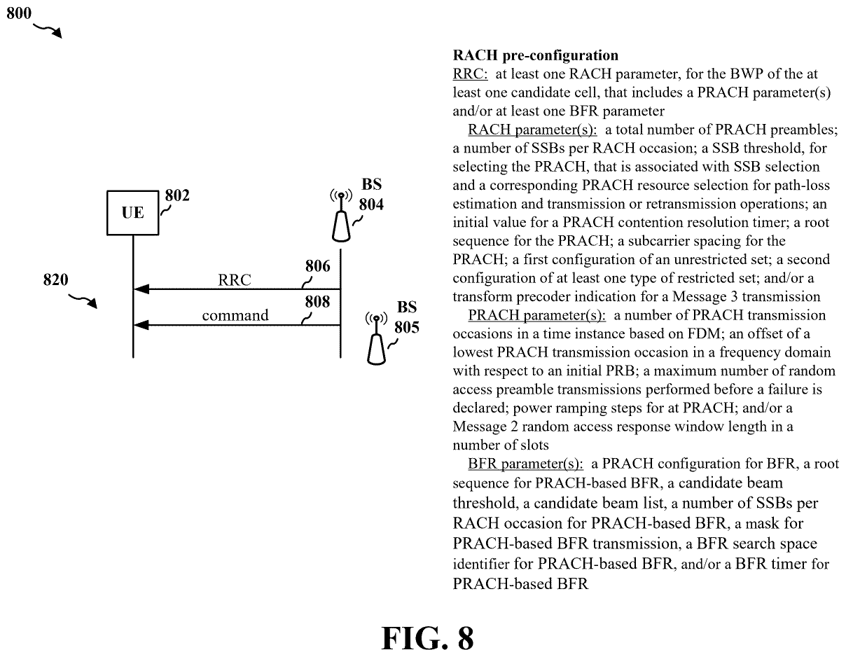

The base station 504 may be configured to provide, and the UE 502 may be configured to receive, a parameter(s) 508. The parameter(s) 508 may include TCI for a beam(s) of candidate cells and/or a RACH parameter(s) for a BWP of candidate cells (e.g., a set of candidate cells that includes the base station 505). In aspects, the TCI for the beam(s) may include legacy and/or unified (e.g., joint) TCI states and associated information for the candidate cells. The parameter(s) 508 may be received by the UE 502 in one or more signaling, and may be provided via RRC signaling, a MAC-CE, and/or DCI, in aspects. Further details regarding the parameter(s) 508 are described below with respect to FIGS. 7, 8.

The base station 504 may be configured to configure, at 509, a switching command 510 for L1/L2 mobility of the UE 502 (e.g., a handoff or move) from the serving cell (e.g., the base station 504) to a candidate cell (e.g., the base station 505) of a set of candidate cells available for the L1/L2 mobility of the UE 502. In aspects, the switching command 510 may be associated with the TCI for a beam(s) and/or at least one RACH parameter for a BWP of the set of candidate cells (e.g., including the base station 505). In some aspects, in addition to or in lieu of the TCI for the beam(s) of the parameter(s) 508 being provided via RRC/MAC-CE/DCI, the switching command 510 may dynamically include the TCI for the beam(s). In such aspects, the switching command 510 may further include a MAC-CE that activates a TCI for the beam(s) for the base station 505 and/or DCI that indicates the TCI for the beam(s).

The switching command 510 may be received by the UE 502, provided from the base station 504. The switching command 510 may indicate a switch associated with L1/L2 mobility of the UE 502 (e.g., a handoff or move) from the serving cell (e.g., the base station 504) to a candidate cell (e.g., the base station 505) of a set of candidate cells available for the L1/L2 mobility of the UE 502.

Subsequent to receiving the switching command 510, the UE 502 may be configured to receive and/or transmit communications 512 with the target candidate cell (e.g., the base station 505 operating as the new serving cell) based on the TCI for the beam(s) and/or the at least one RACH parameter for the BWP. In aspects, the UE 502 may be configured to immediately receive and/or transmit communications 512 with the base station 505 after completion of the handoff initiated by the switching command 510 as the UE is pre-configured with the TCI for the beam(s) and/or the RACH parameter(s) for the BWP of the base station 505. That is, after the handoff to the base station 505, the UE may skip performing configurations for TCI/RACH because of the pre-configuration(s) therefor, thus achieving reductions in mobility latency.

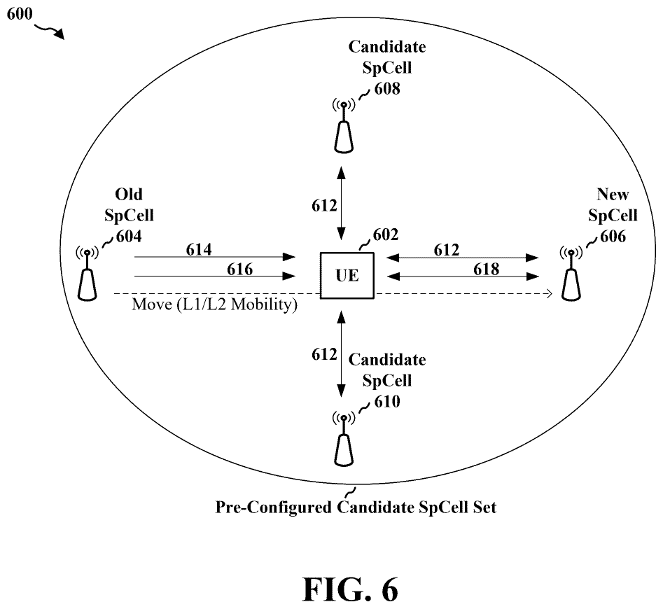

FIG. 6 is a diagram 600 illustrating an example for beam and RACH pre-configuration in UE mobility, in various aspects. In diagram 600, a UE 602 may be initially served by an SpCell 604, while by way of example and not limitation three candidate cells (e.g., a pre-configured candidate SpCell set) are available to the UE 602 for L1/L2 mobility: an SpCell 606, an SpCell 608, and an SpCell 610. After measurements 612, which may be L1 measurements, are performed by the UE 602 against the SpCell 606, the SpCell 608, and the SpCell 610, as shown, the UE 602 may be provided with pre-configuration information 614 (e.g., TCI for a beam(s) of the candidate cells and/or provided with a RACH parameter(s) for a BWP of the candidate cells). In aspects, the pre-configuration information 614 may be provided via RRC/MAC-CE/DCI and/or a mobility command 616.

The UE 602 may receive the mobility command 616, e.g., subsequent to the pre-configuration information 614 and/or including the pre-configuration information 614), and the mobility command 616 may cause the UE 602 to move, via L1/L2 mobility, from the serving cell, e.g., SpCell 604, to the candidate cell, e.g., SpCell 606, which becomes the new serving cell by handoff. Accordingly, the UE 602 is enabled to receive and/or transmit communications 618 with the SpCell 606 at the completion of the handoff based on the pre-configurations for beams, RACH, etc., as described herein. That is, additional configuration and/or setup may be skipped for receiving and/or transmitting communications 618 as the pre-configuration for TCI and RACH, described herein, has been performed, thus reducing mobility latency for the UE handoff.

FIG. 7 is a diagram 700 illustrating an example for beam pre-configuration in UE mobility, in various aspects. Diagram 700 may be a further aspect of call flow diagram 500 in FIG. 5, and shows a configuration 720 for legacy TCI, a configuration 730 for unified TCI, and a configuration 740 for command-based TCI, each for L1/L2 mobility of a UE 702 at a serving cell (e.g., a base station 704) with pre-configurations for beam setup at a candidate/new cell (e.g., a base station 705) prior to moving from a serving cell to the candidate/new cell (e.g., from the base station 704 to the base station 705).

For example, the configuration 720 for legacy TCI illustrates the UE 702 receiving RRC signaling 706, a MAC-CE 708, DCI 710, and a mobility command 712 from the base station 704 for an L1/L2 move to the base station 705. In the configuration 720 for legacy TCI, the RRC signaling 706 provided by the base station 704 and received by the UE 702 may include at least one of a first legacy TCI state for a periodic CSI-RS; legacy spatial relation information for a periodic SRS or a PUCCH; and/or a list of legacy TCI states for a PDSCH. In the configuration 720 for legacy TCI, the MAC-CE 708 provided by the base station 704 and received by the UE 702 may include at least one of a second legacy TCI state for a CORESET or a semi-persistent CSI-RS; legacy spatial relation information for at least one of a semi-persistent SRS, an aperiodic SRS, or the PUCCH; a subset of legacy TCI states for the PDSCH; and/or a path loss RS for at least one SRS or at least one PUSCH. In the configuration 720 for legacy TCI, the DCI 710 provided by the base station 704 and received by the UE 702 may indicate a third legacy TCI state of the subset of the legacy TCI states for the PDSCH. The UE 702 may receive a legacy TCI state indication per each channel or reference signal.

Based on receiving the mobility command 708, the UE 702 may move via L1/L2 mobility from the base station 704 to the base station 705 having already configured a beam(s) for communication with the base station 705, as described above.

The configuration 730 for unified TCI also illustrates the UE 702 receiving RRC signaling 706, a MAC-CE 708, DCI 710, and a mobility command 712 from the base station 704 for an L1/L2 move to the base station 705, yet in the configuration 730, the information/configuration(s) provided to the UE 702 for unified TCI is different than those provided in the configuration 720. In the configuration 730 for unified TCI, the RRC signaling 706 provided by the base station 704 and received by the UE 702 may include at least one of a first unified TCI state for periodic CSI-RS or a periodic SRS that are configured not to follow unified TCI indications; and/or at least one of a list of joint TCI states, and a list of downlink TCI states and a list of uplink TCI states. In the configuration 730 for unified TCI, the MAC-CE 708 provided by the base station 704 and received by the UE 702 may include at least one of a second unified TCI state for at least one of a CORESET; a semi-persistent CSI-RS; a semi-persistent SRS; and/or an aperiodic SRS, which are configured not to follow the unified TCI indications. In the configuration 730 for unified TCI, the DCI 710 provided by the base station 704 and received by the UE 702 may indicate a joint TCI state for at least one of a PDSCH, a PDCCH, a PUSCH, a PUCCH, a CSI-RS, or a SRS, which are configured to follow the unified TCI indications; a downlink TCI state for at least one of the PDSCH, the PDCCH, or the CSI-RS, which are configured to follow the unified TCI indications; and/or an uplink TCI state for the PUSCH, the PUCCH, or the SRS, which are configured to follow the unified TCI indications. The UE 702 may receive a unified TCI state indication for multiple channels or reference signals.

Based on receiving the mobility command 708, the UE 702 may move via L1/L2 mobility from the base station 704 to the base station 705 having already configured a beam(s) for communication with the base station 705, as described above.

The configuration 740 for command-based TCI also illustrates the UE 702 receiving the mobility command 712 from the base station 704 for an L1/L2 move to the base station 705. That is, aspects include the ability of the UE 702 to be pre-configured for L1/L2 mobility, prior to moving from the base station 704 to the base station 705, via the mobility command 712, e.g., without the RRC signaling 706, the MAC-CE 708, and/or the DCI 710 described above for the configuration 720 and the configuration 730. The mobility command 712 in the configuration 740 may include at least one of a first legacy TCI state for a periodic CSI-RS; legacy spatial relation information for a periodic SRS or a PUCCH; a second legacy TCI state for a CORESET or a semi-persistent CSI-RS; legacy spatial relation information for at least one of a semi-persistent SRS, an aperiodic SRS, or the PUCCH; a path loss RS for at least one of a SRS or a PUSCH; and/or a third legacy TCI state for a PDSCH. The mobility command 712 may include a MAC-CE that may activate the TCI for the beam, and the mobility command 712 may include DCI that may indicate the TCI for the beam.

Based on receiving the mobility command 708, the UE 702 may move via L1/L2 mobility from the base station 704 to the base station 705 having already configured a beam(s) for communication with the base station 705, as described above.

FIG. 8 is a diagram 800 illustrating an example for RACH pre-configuration in UE mobility, in various aspects. Diagram 800 may be a further aspect of call flow diagram 500 in FIG. 5, and shows a configuration 820 for L1/L2 mobility of a UE 802 at a serving cell (e.g., a base station 804) with pre-configurations for RACH setup for a BWP of a set of candidate cells including at a candidate/new cell (e.g., a base station 805) prior to moving from a serving cell to the candidate/new cell (e.g., from the base station 804 (serving) to the base station 805 (candidate/new/target)).

For example, the configuration 820 for RACH pre-configuration in UE mobility illustrates the UE 802 receiving RRC signaling 806 and a mobility command 808 from the base station 804 for an L1/L2 move to the base station 805. In the configuration 820 for RACH pre-configuration, the RRC signaling 806 provided by the base station 804 and received by the UE 802 may include at least one RACH parameter, for a BWP of at least one candidate cell, e.g., the base station 805, that includes a PRACH parameter(s) and/or at least one beam failure recovery (BFR) parameter for transmissions in a BWP of candidate cells.

In aspects, the RACH parameter(s) may include at least one of a general PRACH parameter (e.g., “rach-ConfigGeneric”), a total number of PRACH preambles; a number of SSBs per RACH occasion; a SSB threshold for selecting the PRACH (e.g., that is associated with SSB selection and a corresponding PRACH resource selection for path-loss estimation and transmission or retransmission operations); an initial value for a PRACH contention resolution timer; a root sequence for the PRACH; a subcarrier spacing for the PRACH; a first configuration of an unrestricted set; a second configuration of at least one type of restricted set; and/or a transform precoder indication for a Message 3 (Msg3) transmission. In some aspects, SSB-based PRACH may be utilized for uplink BWPs when the linked downlink BWPs (e.g., having a same BWP identifier as the uplink BWP) are the initial downlink BWPs or downlink BWPs containing the SSB associated with the initial downlink BWP in a candidate cell. In aspects, the PRACH parameter(s) may include at least one of a number of PRACH transmission occasions in a time instance based on FDM; an offset of a lowest PRACH transmission occasion in a frequency domain with respect to an initial PRB; a maximum number of random access preamble transmissions performed before a failure is declared; power ramping steps for at PRACH; and/or a Message 2 random access response window length in a number of slots. In aspects, the BFR parameter(s) may include at least one of a PRACH configuration for BFR (e.g., “rach-ConfigBFR,” “rach-ConfigGeneric”), a root sequence for PRACH-based BFR, a candidate beam threshold (e.g., “rsrp-ThresholdSSB”), a candidate beam list (e.g., “candidateBeamRSList”), a number of SSBs per RACH occasion for PRACH-based BFR, a mask for PRACH-based BFR transmission (e.g., “ra-ssb-OccasionMaskIndex”), a BFR search space identifier for PRACH-based BFR, a BFR timer for PRACH-based BFR (e.g., “beamFailureRecoveryTimer”), and/or the like. In aspects, PRACH-based BFR may be configurable in candidate special cells.

Based on receiving the mobility command 808, the UE 802 may move via L1/L2 mobility from the base station 804 to the base station 805 having already configured a RACH for communication with the base station 805, as described above.

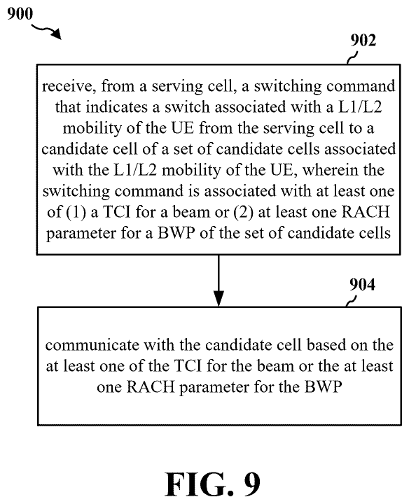

FIG. 9 is a flowchart 900 of a method of wireless communication, in various aspects. The method may be performed by a UE (e.g., the UE 104, 402, 502, 602, 702, 802; the apparatus 1304). In some aspects, the method may include aspects described in connection with the communication flow in FIG. 5 and/or aspects described in FIGS. 6, 7, 8. The method provides improvements in UE mobility that enables a UE to utilize L1/L2 mobility through pre-configurations of TCI for beams and of RACH for a BWP of candidate cells, as well as dynamic pre-configurations via mobility commands, which improve mobility latency.

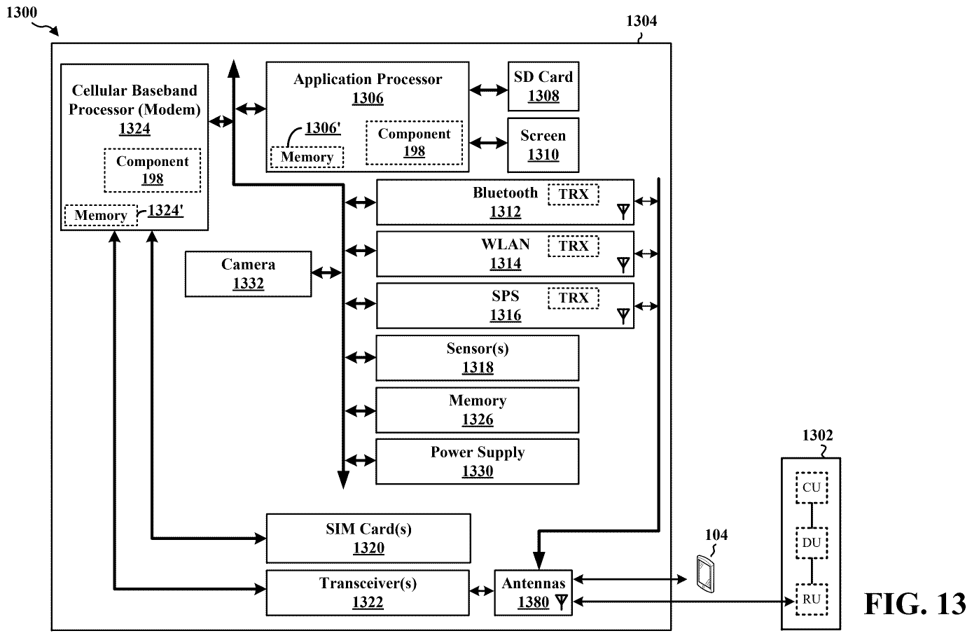

At 902, the UE receives, from a serving cell, a switching command that indicates a switch associated with a L1/L2 mobility of the UE from the serving cell to a candidate cell of a set of candidate cells associated with the L1/L2 mobility of the UE, where the switching command is associated with at least one of (1) a TCI for a beam or (2) at least one RACH parameter for a BWP of the set of candidate cells. As an example, the reception may be performed by one or more of the component 198, the transceiver 1322, and/or the antenna 1380 in FIG. 13. FIG. 5 illustrates an example of the UE 502 receiving a switching command 510 for L1/L2 mobility from a serving cell (e.g., the base station 504).

The switching command 510 may indicate a switch associated with L1/L2 mobility of the UE 502 (e.g., a handoff or move) from the serving cell (e.g., the base station 504) to a candidate cell (e.g., the base station 505) of a set of candidate cells available for the L1/L2 mobility of the UE 502. In aspects, the switching command 510 may be associated with the TCI for a beam(s) and/or at least one RACH parameter for a BWP of the set of candidate cells (e.g., including the base station 505). In some aspects, in addition to or in lieu of the TCI for the beam(s) of the parameter(s) 508 being provided via RRC/MAC-CE/DCI, the switching command 510 may dynamically include the TCI for the beam(s). In such aspects, the switching command 510 may further include a MAC-CE that activates a TCI for the beam(s) for the base station 505 and/or DCI that indicates the TCI for the beam(s).

At 904, the UE communicates with the candidate cell based on the at least one of the TCI for the beam or the at least one RACH parameter for the BWP. As an example, the communication may be performed by one or more of the component 198, the transceiver 1322, and/or the antenna 1380 in FIG. 13. FIG. 5 illustrates an example of the UE 502 communicating with a target cell (e.g., the base station 505) based on the pre-configured TCI for the beam and/or the RACH parameter(s) for the BWP of the target cell subsequent to the switching command 510 for L1/L2 mobility from the serving cell (e.g., the base station 504) initiating and completing the handoff/move therefrom.

In other words, subsequent to receiving the switching command 510, the UE 502 may be configured to receive and/or transmit communications 512 with the target candidate cell (e.g., the base station 505 operating as the new serving cell) based on the TCI for the beam(s) and/or the at least one RACH parameter for the BWP. In aspects, the UE 502 may be configured to immediately receive and/or transmit the communications 512 with the base station 505 after completion of the handoff initiated by the switching command 510 as the UE is pre-configured with the TCI for the beam(s) and/or the RACH parameter(s) for the BWP of the base station 505. That is, after the handoff to the base station 505, the UE may skip performing configurations for TCI/RACH because of the pre-configuration(s) therefor, thus achieving reductions in mobility latency.

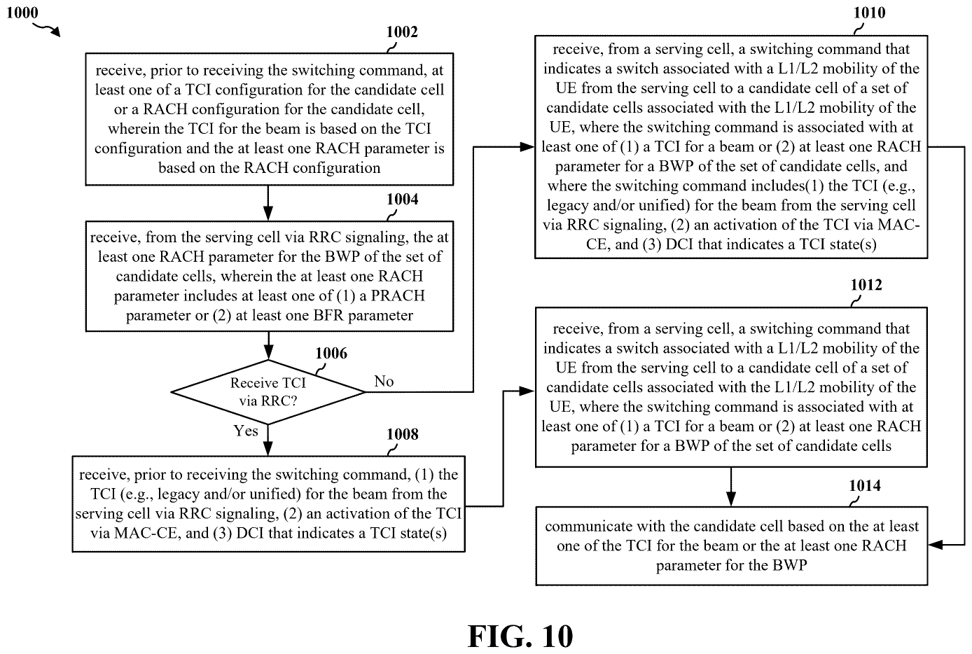

FIG. 10 is a flowchart 1000 of a method of wireless communication, in various aspects. The method may be performed by a UE (e.g., the UE 104, 402, 502, 602, 702, 802; the apparatus 1304). In some aspects, the method may include aspects described in connection with the communication flow in FIG. 5 and/or aspects described in FIGS. 6, 7, 8. The method provides improvements in UE mobility that enables a UE to utilize L1/L2 mobility through pre-configurations of TCI for beams and of RACH for a BWP of candidate cells, as well as dynamic pre-configurations via mobility commands, which improve mobility latency.

At 1002, the UE receives, prior to receiving the switching command, at least one of a TCI configuration for the candidate cell or a RACH configuration for the candidate cell, where the TCI for the beam is based on the TCI configuration and the at least one RACH parameter is based on the RACH configuration. As an example, the reception may be performed by one or more of the component 198, the transceiver 1322, and/or the antenna 1380. FIG. 5 illustrates an example of the UE 502 receiving the configuration(s) 506 from a serving cell (e.g., the base station 504), which may include a TCI configuration and/or a RACH configuration for the candidate cell (e.g., the base station 505).

The configuration(s) 506 may include a TCI configuration for a candidate cell (e.g., the base station 505) and/or a RACH configuration for the candidate cell (e.g., the base station 505), where the TCI for the beam, as described herein, may be based on the TCI configuration and the at least one RACH parameter, as described herein, may be based on the RACH configuration. In aspects, the configuration(s) 506 may include a single signaling or multiple signaling, and the configuration(s) 506 may be provided by the base station 504 via RRC signaling. As described in further detail below, the configuration(s) 506 may be based on prior L1 measurements of a set of candidate cells (e.g., including the base station 505) performed by the UE 502.

At 1004, the UE receives, from the serving cell via RRC signaling, the at least one RACH parameter for the BWP of the set of candidate cells, where the at least one RACH parameter includes at least one of (1) a PRACH parameter or (2) at least one BFR parameter. As an example, the reception may be performed by one or more of the component 198, the transceiver 1322, and/or the antenna 1380. FIG. 5 illustrates an example of the base station 504 providing the parameter(s) 508 that are received by the UE 502.

The base station 504 may be configured to provide, and the UE 502 may be configured to receive, the parameter(s) 508. The parameter(s) 508 may include a RACH parameter(s) for a BWP of candidate cells (e.g., a set of candidate cells that includes the base station 505). In aspects, the RACH parameter(s) of the parameter(s) 508 may be provided via RRC signaling (e.g., 806 in FIG. 8), in aspects. Further details regarding the parameter(s) 508 are described with respect to FIG. 8.

At 1006, it is determined if the TCI will be received by the UE via RRC (e.g., followed by a MAC-CE and DCI). As an example, the determination may be performed by the component 198. If the TCI will be received by the UE via RRC, flowchart 1000 continues to 1008; if not, flowchart 1000 continues to 1010 where the TCI may be included dynamically in a mobility command.

At 1008, the UE receives, prior to the switching command, (1) the TCI (e.g., legacy and/or unified) for the beam from the serving cell via RRC signaling, (2) an activation of the TCI via MAC-CE, and (3) DCI that indicates a TCI state(s). As an example, the reception may be performed by one or more of the component 198, the transceiver 1322, and/or the antenna 1380. FIG. 5 illustrates an example of the base station 504 providing the parameter(s) 508 that are received by the UE 502.

The base station 504 may be configured to provide, and the UE 502 may be configured to receive, the parameter(s) 508. The parameter(s) 508 may include TCI for a beam(s) of candidate cells (e.g., a set of candidate cells that includes the base station 505). In aspects, the TCI for the beam(s) may include legacy and/or unified (e.g., joint) TCI states and associated information for the candidate cells. The parameter(s) 508 may be received by the UE 502 in one or more signaling, and may be provided via RRC signaling (e.g., 706 in FIG. 7), a MAC-CE signaling (e.g., 708 in FIG. 7), and/or DCI (e.g., 710 in FIG. 7), in aspects. Further details regarding the parameter(s) 508 are described with respect to FIG. 7.

From 1008, flowchart 1000 may continue to 1012.

At 1010, the UE receives, from a serving cell, a switching command that indicates a switch associated with a L1/L2 mobility of the UE from the serving cell to a candidate cell of a set of candidate cells associated with the L1/L2 mobility of the UE, where the switching command is associated with at least one of (1) a TCI for a beam or (2) at least one RACH parameter for a BWP of the set of candidate cells, and where the switching command includes (1) the TCI (e.g., legacy and/or unified) for the beam from the serving cell via RRC signaling, (2) an activation of the TCI via MAC-CE, and (3) DCI that indicates a TCI state(s). As an example, the reception may be performed by one or more of the component 198, the transceiver 1322, and/or the antenna 1380. FIG. 5 illustrates an example of the UE 502 receiving a switching command 510 for L1/L2 mobility from a serving cell (e.g., the base station 504).

The switching command 510 may indicate a switch associated with L1/L2 mobility of the UE 502 (e.g., a handoff or move) from the serving cell (e.g., the base station 504) to a candidate cell (e.g., the base station 505) of a set of candidate cells available for the L1/L2 mobility of the UE 502. In aspects, the switching command 510 may be associated with the TCI for a beam(s) and/or at least one RACH parameter for a BWP of the set of candidate cells (e.g., including the base station 505). In some aspects, in addition to or in lieu of the TCI for the beam(s) of the parameter(s) 508 being provided via RRC/MAC-CE/DCI (e.g., as described with respect to 1008 above), the switching command 510 may dynamically include the TCI for the beam(s). In such aspects, the switching command 510 may further include a MAC-CE that activates a TCI for the beam(s) for the base station 505 and/or DCI that indicates the TCI for the beam(s).

From 1010, flowchart 1000 may continue to 1014.

At 1012, the UE receives, from a serving cell, a switching command that indicates a switch associated with a L1/L2 mobility of the UE from the serving cell to a candidate cell of a set of candidate cells associated with the L1/L2 mobility of the UE, where the switching command is associated with at least one of (1) a TCI for a beam or (2) at least one RACH parameter for a BWP of the set of candidate cells. As an example, the reception may be performed by one or more of the component 198, the transceiver 1322, and/or the antenna 1380. FIG. 5 illustrates an example of the UE 502 receiving a switching command 510 for L1/L2 mobility from a serving cell (e.g., the base station 504).

The switching command 510 may indicate a switch associated with L1/L2 mobility of the UE 502 (e.g., a handoff or move) from the serving cell (e.g., the base station 504) to a candidate cell (e.g., the base station 505) of a set of candidate cells available for the L1/L2 mobility of the UE 502. In aspects, the switching command 510 may be associated with the TCI for a beam(s) and/or at least one RACH parameter for a BWP of the set of candidate cells (e.g., including the base station 505).

At 1014, the UE communicates with the candidate cell based on the at least one of the TCI for the beam or the at least one RACH parameter for the BWP. As an example, the communication may be performed by one or more of the component 198, the transceiver 1322, and/or the antenna 1380. FIG. 5 illustrates an example of the UE 502 communicating with a target cell (e.g., the base station 505) based on the pre-configured TCI for the beam and/or the RACH parameter(s) for the BWP of the target cell subsequent to the switching command 510 for L1/L2 mobility from the serving cell (e.g., the base station 504) initiating and completing the handoff/move therefrom.

In other words, subsequent to receiving the switching command 510, the UE 502 may be configured to receive and/or transmit communications 512 with the target candidate cell (e.g., the base station 505 operating as the new serving cell) based on the TCI for the beam(s) and/or the at least one RACH parameter for the BWP. In aspects, the UE 502 may be configured to immediately receive and/or transmit the communications 512 with the base station 505 after completion of the handoff initiated by the switching command 510 as the UE is pre-configured with the TCI for the beam(s) and/or the RACH parameter(s) for the BWP of the base station 505. That is, after the handoff to the base station 505, the UE may skip performing configurations for TCI/RACH because of the pre-configuration(s) therefor, thus achieving reductions in mobility latency.

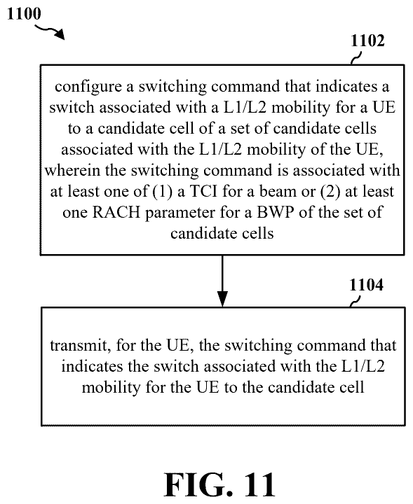

FIG. 11 is a flowchart 1100 of a method of wireless communication, in various aspects. The method may be performed by a base station and/or a serving cell (e.g., the base station 102, 504, 704, 804; the SpCell 404, 604; the network entity 1302, 1402, 1560. In some aspects, the method may include aspects described in connection with the communication flow in FIG. 5 and/or aspects described in FIGS. 6, 7, 8. The method provides improvements in UE mobility that enables a UE to utilize L1/L2 mobility through pre-configurations of TCI for beams and of RACH for a BWP of candidate cells, as well as dynamic pre-configurations via mobility commands, which improve mobility latency.

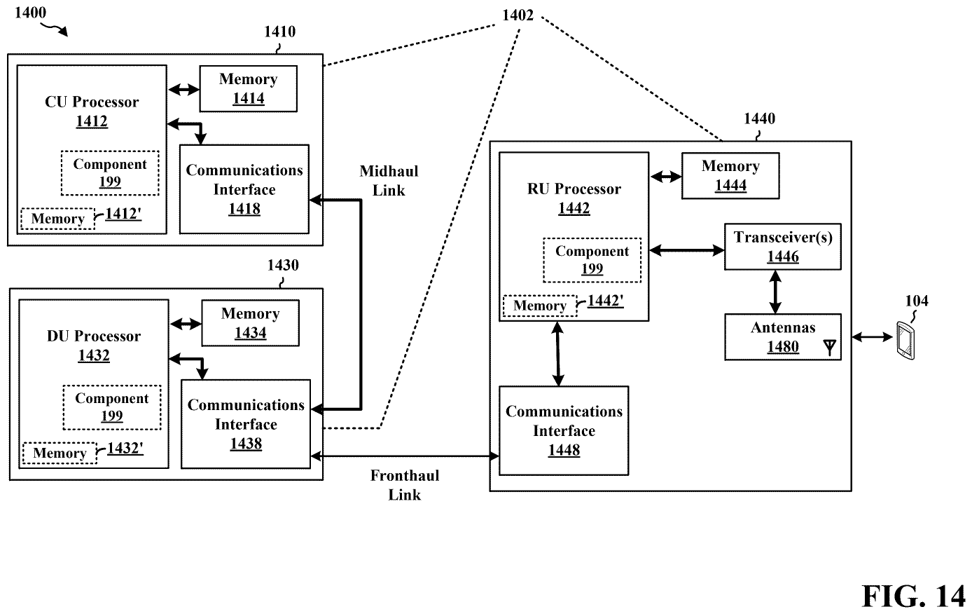

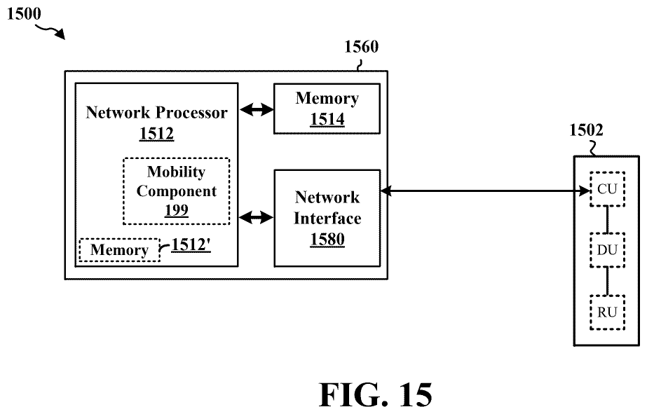

At 1102, the base station configures a switching command that indicates a switch associated with a L1/L2 mobility for a UE to a candidate cell of a set of candidate cells associated with the L1/L2 mobility of the UE, where the switching command is associated with at least one of (1) a TCI for a beam or (2) at least one RACH parameter for a BWP of the set of candidate cells. As an example, the providing of the configuration may be performed, e.g., by any of the component 199, the transceiver 1446 and/or the antenna 1480 in FIG. 14, the network interface 1580 in FIG. 15. FIG. 5 illustrates an example of the base station 504 configuring (at 509) the switching command 510.

The switching command 510 may be configured by the base station 504 for L1/L2 mobility of the UE 502 (e.g., a handoff or move) from a serving cell (e.g., the base station 504) to a candidate cell (e.g., the base station 505) of a set of candidate cells available for the L1/L2 mobility of the UE 502. In aspects, the switching command 510 may be configured as being associated with the TCI for a beam(s) and/or at least one RACH parameter for a BWP of the set of candidate cells (e.g., including the base station 505). In some aspects, in addition to or in lieu of the TCI for the beam(s) of the parameter(s) 508 being provided via RRC/MAC-CE/DCI, the switching command 510 may be configured to include the TCI for the beam(s) for dynamic mobility of the UE 502. In such aspects, the switching command 510 may be configured to further include a MAC-CE that activates a TCI for the beam(s) for the base station 505 and/or DCI that indicates the TCI for the beam(s).

At 1104, the base station transmits, for the UE, the switching command that indicates the switch associated with the L1/L2 mobility for the UE to the candidate cell. As an example, the providing of the configuration may be performed, e.g., by any of the component 199, the transceiver 1446 and/or the antenna 1480 in FIG. 14, the network interface 1580 in FIG. 15. FIG. 5 illustrates an example of the base station 504 providing the switching command 510 to the UE 502.

The switching command 510 may be received by the UE 502, provided from the base station 504, and may indicate a switch associated with L1/L2 mobility of the UE 502 (e.g., a handoff or move) from the serving cell (e.g., the base station 504) to a candidate cell (e.g., the base station 505) of a set of candidate cells available for the L1/L2 mobility of the UE 502.

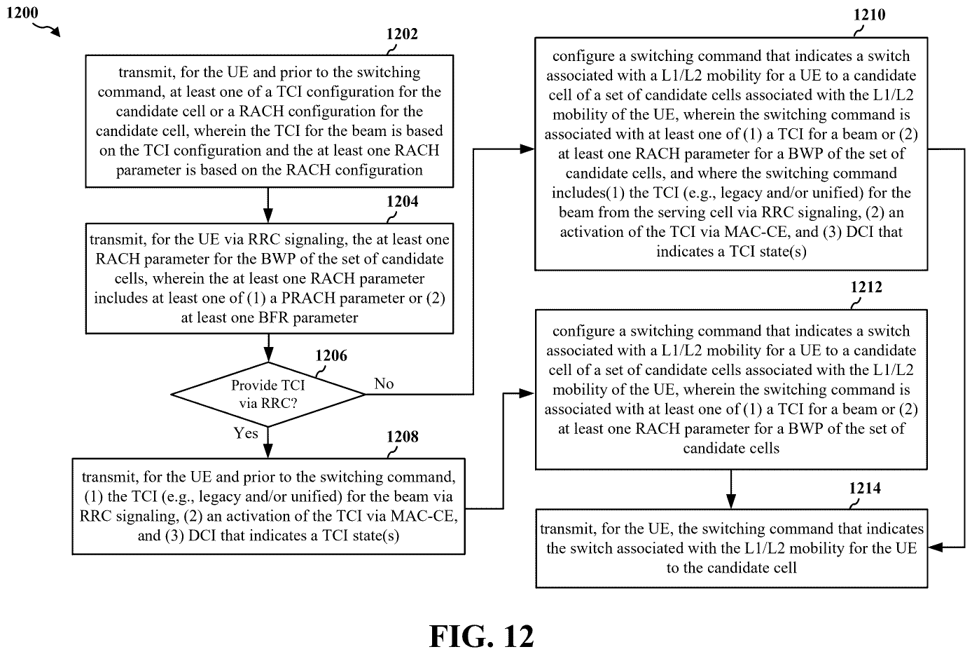

FIG. 12 is a flowchart 1200 of a method of wireless communication, in various aspects. The method may be performed by a base station and/or a serving cell (e.g., the base station 102, 504, 704, 804; the SpCell 404, 604; the network entity 1302, 1402, 1560. In some aspects, the method may include aspects described in connection with the communication flow in FIG. 5 and/or aspects described in FIGS. 6, 7, 8. The method provides improvements in UE mobility that enables a UE to utilize L1/L2 mobility through pre-configurations of TCI for beams and of RACH for a BWP of candidate cells, as well as dynamic pre-configurations via mobility commands, which improve mobility latency.

At 1202, the base station transmits, for the UE and prior to a switching command, at least one of a TCI configuration for the candidate cell or a RACH configuration for the candidate cell, where a TCI for a beam is based on the TCI configuration and at least one RACH parameter is based on the RACH configuration. As an example, the transmitting, or providing, of the configuration(s) may be performed, e.g., by any of the component 199, the transceiver 1446 and/or the antenna 1480 in FIG. 14, the network interface 1580 in FIG. 15. FIG. 5 illustrates an example of the base station 504 providing the configuration(s) 506 to the UE 502.

The configuration(s) 506 may include a TCI configuration for a candidate cell (e.g., the base station 505) and/or a RACH configuration for the candidate cell (e.g., the base station 505), where the TCI for the beam, as described herein, may be based on the TCI configuration and the at least one RACH parameter, as described herein, may be based on the RACH configuration. In aspects, the configuration(s) 506 may include a single signaling or multiple signaling, and the configuration(s) 506 may be provided by the base station 504 via RRC signaling. As described in further detail below, the configuration(s) 506 may be based on prior L1 measurements of a set of candidate cells (e.g., including the base station 505) performed by the UE 502.

At 1204, the base station transmits, for the UE via RRC signaling, the at least one RACH parameter for the BWP of the set of candidate cells, where the at least one RACH parameter includes at least one of (1) a PRACH parameter or (2) at least one BFR parameter. As an example, the transmitting, or providing, may be performed, e.g., by any of the component 199, the transceiver 1446 and/or the antenna 1480 in FIG. 14, the network interface 1580 in FIG. 15. FIG. 5 illustrates an example of the base station 504 providing the parameter(s) 508 to the UE 502.

The base station 504 may be configured to provide, and the UE 502 may be configured to receive, the parameter(s) 508. The parameter(s) 508 may include a RACH parameter(s) for a BWP of candidate cells (e.g., a set of candidate cells that includes the base station 505). In aspects, the RACH parameter(s) of the parameter(s) 508 may be provided via RRC signaling (e.g., 806 in FIG. 8), in aspects. Further details regarding the parameter(s) 508 are described with respect to FIG. 8.

At 1206, it is determined if the TCI will be provided by the serving cell to the UE via RRC (e.g., followed by a MAC-CE and DCI). As an example, the determination may be performed by one or more of the component 199. If the TCI will be provided by the serving cell and received by the UE via RRC, flowchart 1200 continues to 1208; if not, flowchart 1200 continues to 1210 where the TCI may be included dynamically in a mobility command.

At 1208, the base station transmits, prior to the switching command, (1) the TCI (e.g., legacy and/or unified) for the beam from the serving cell via RRC signaling, (2) an activation of the TCI via MAC-CE, and (3) DCI that indicates a TCI state(s). As an example, the transmitting, or providing, may be performed, e.g., by any of the component 199, the transceiver 1446 and/or the antenna 1480 in FIG. 14, the network interface 1580 in FIG. 15. FIG. 5 illustrates an example of the base station 504 providing the parameter(s) 508 that are received by the UE 502.

The base station 504 may be configured to provide, and the UE 502 may be configured to receive, the parameter(s) 508. The parameter(s) 508 may include TCI for a beam(s) of candidate cells (e.g., a set of candidate cells that includes the base station 505). In aspects, the TCI for the beam(s) may include legacy and/or unified (e.g., joint) TCI states and associated information for the candidate cells. The parameter(s) 508 may be received by the UE 502 in one or more signaling, and may be provided via RRC signaling (e.g., 706 in FIG. 7), a MAC-CE signaling (e.g., 708 in FIG. 7), and/or DCI (e.g., 710 in FIG. 7), in aspects. Further details regarding the parameter(s) 508 are described with respect to FIG. 7.

From 1208, flowchart 1000 may continue to 1212.

At 1210, the base station configures a switching command that indicates a switch associated with a L1/L2 mobility for a UE to a candidate cell of a set of candidate cells associated with the L1/L2 mobility of the UE, where the switching command is associated with at least one of (1) a TCI for a beam or (2) at least one RACH parameter for a BWP of the set of candidate cells, and where the switching command includes (1) the TCI (e.g., legacy and/or unified) for the beam from the serving cell via RRC signaling, (2) an activation of the TCI via MAC-CE, and (3) DCI that indicates a TCI state(s). As an example, the transmitting, or providing, may be performed, e.g., by any of the component 199, the transceiver 1446 and/or the antenna 1480 in FIG. 14, the network interface 1580 in FIG. 15. FIG. 5 illustrates an example of the UE 502 receiving a switching command 510 for L1/L2 mobility from a serving cell (e.g., the base station 504).

The switching command 510 may indicate a switch associated with L1/L2 mobility of the UE 502 (e.g., a handoff or move) from the serving cell (e.g., the base station 504) to a candidate cell (e.g., the base station 505) of a set of candidate cells available for the L1/L2 mobility of the UE 502. In aspects, the switching command 510 may be associated with the TCI for a beam(s) and/or at least one RACH parameter for a BWP of the set of candidate cells (e.g., including the base station 505). In some aspects, in addition to or in lieu of the TCI for the beam(s) of the parameter(s) 508 being provided via RRC/MAC-CE/DCI (e.g., as described with respect to 1008 above), the switching command 510 may dynamically include the TCI for the beam(s). In such aspects, the switching command 510 may further include a MAC-CE that activates a TCI for the beam(s) for the base station 505 and/or DCI that indicates the TCI for the beam(s).

From 1210, flowchart 1200 may continue to 1214.

At 1212, the base station configures a switching command that indicates a switch associated with a L1/L2 mobility for a UE to a candidate cell of a set of candidate cells associated with the L1/L2 mobility of the UE, where the switching command is associated with at least one of (1) a TCI for a beam or (2) at least one RACH parameter for a BWP of the set of candidate cells. As an example, the providing of the configuration may be performed, e.g., by any of the component 199, the transceiver 1446 and/or the antenna 1480 in FIG. 14, the network interface 1580 in FIG. 15. FIG. 5 illustrates an example of the base station 504 configuring (at 509) the switching command 510.

The switching command 510 may be configured by the base station 504 for L1/L2 mobility of the UE 502 (e.g., a handoff or move) from a serving cell (e.g., the base station 504) to a candidate cell (e.g., the base station 505) of a set of candidate cells available for the L1/L2 mobility of the UE 502. In aspects, the switching command 510 may be configured as being associated with the TCI for a beam(s) and/or at least one RACH parameter for a BWP of the set of candidate cells (e.g., including the base station 505).

At 1214, the base station transmits, for the UE, the switching command that indicates the switch associated with the L1/L2 mobility for the UE to the candidate cell. As an example, the providing of the configuration may be performed, e.g., by any of the component 199, the transceiver 1446 and/or the antenna 1480 in FIG. 14, the network interface 1580 in FIG. 15. FIG. 5 illustrates an example of the base station 504 providing the switching command 510 to the UE 502.

The switching command 510 may be received by the UE 502, provided from the base station 504, and may indicate a switch associated with L1/L2 mobility of the UE 502 (e.g., a handoff or move) from the serving cell (e.g., the base station 504) to a candidate cell (e.g., the base station 505) of a set of candidate cells available for the L1/L2 mobility of the UE 502.

FIG. 13 is a diagram 1300 illustrating an example of a hardware implementation for an apparatus 1304. The apparatus 1304 may be a UE, a component of a UE, or may implement UE functionality. In some aspects, the apparatus 1304 may include a cellular baseband processor 1324 (also referred to as a modem) coupled to one or more transceivers 1322 (e.g., cellular RF transceiver). The cellular baseband processor 1324 may include on-chip memory 1324′. In some aspects, the apparatus 1304 may further include one or more subscriber identity modules (SIM) cards 1320 and an application processor 1306 coupled to a secure digital (SD) card 1308 and a screen 1310. The application processor 1306 may include on-chip memory 1306′. In some aspects, the apparatus 1304 may further include a Bluetooth module 1312, a WLAN module 1314, an SPS module 1316 (e.g., GNSS module), one or more sensor modules 1318 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1326, a power supply 1330, and/or a camera 1332. The Bluetooth module 1312, the WLAN module 1314, and the SPS module 1316 may include an on-chip transceiver (TRX) (or in some cases, just a receiver (RX)). The Bluetooth module 1312, the WLAN module 1314, and the SPS module 1316 may include their own dedicated antennas and/or utilize the antennas 1380 for communication. The cellular baseband processor 1324 communicates through the transceiver(s) 1322 via one or more antennas 1380 with the UE 104 and/or with an RU associated with a network entity 1302. The cellular baseband processor 1324 and the application processor 1306 may each include a computer-readable medium/memory 1324′, 1306′, respectively. The additional memory modules 1326 may also be considered a computer-readable medium/memory. Each computer-readable medium/memory 1324′, 1306′, 1326 may be non-transitory. The cellular baseband processor 1324 and the application processor 1306 are each responsible for general processing, including the execution of software stored on the computer-readable medium/memory. The software, when executed by the cellular baseband processor 1324/application processor 1306, causes the cellular baseband processor 1324/application processor 1306 to perform the various functions described supra. The computer-readable medium/memory may also be used for storing data that is manipulated by the cellular baseband processor 1324/application processor 1306 when executing software. The cellular baseband processor 1324/application processor 1306 may be a component of the UE 350 and may include the memory 360 and/or at least one of the TX processor 368, the RX processor 356, and the controller/processor 359. In one configuration, the apparatus 1304 may be a processor chip (modem and/or application) and include just the cellular baseband processor 1324 and/or the application processor 1306, and in another configuration, the apparatus 1304 may be the entire UE (e.g., see UE 350 of FIG. 3) and include the additional modules of the apparatus 1304.

As discussed supra, the component 198 may be configured to receive, from a serving cell, a switching command that indicates a switch associated with L1/L2 mobility of the UE from the serving cell to a candidate cell of a set of candidate cells associated with the L1/L2 mobility of the UE, where the switching command is associated with at least one of (1) a TCI for a beam or (2) at least one RACH parameter for a BWP of the set of candidate cells. The component 198 is also configured to communicate with the candidate cell based on the at least one of the TCI for the beam or the at least one RACH parameter for the BWP. In aspects, the component 198 may be configured to receive, prior to receiving the switching command, at least one of a TCI configuration for the candidate cell or a RACH configuration for the candidate cell, where the TCI for the beam is based on the TCI configuration and the at least one RACH parameter is based on the RACH configuration. In aspects, the component 198 may be configured to receive the TCI for the beam from the serving cell via RRC signaling and prior to receiving the switching command, where the TCI for the beam includes at least one of: a first legacy TCI state for a periodic CSI-RS, first legacy spatial relation information for a periodic SRS or a PUCCH, or a list of legacy TCI states for a PDSCH. In aspects, the component 198 may be configured to receive an activation of the TCI for the beam via a MAC-CE that includes at least one of: a second legacy TCI state for a CORESET or a semi-persistent CSI-RS, second legacy spatial relation information for at least one of a semi-persistent SRS, an aperiodic SRS, or the PUCCH, a subset of legacy TCI states for the PDSCH, or a path loss RS for at least one SRS or at least one physical uplink shared channel PUSCH. In aspects, the component 198 may be configured to receive DCI that indicates a third legacy TCI state of the subset of the legacy TCI states for the PDSCH. In aspects, the component 198 may be configured to receive the TCI for the beam from the serving cell via RRC signaling and prior to receiving the switching command, where the TCI for the beam includes at least one of: a first unified TCI state for periodic CSI-RS or a periodic SRS that are configured not to follow unified TCI indications, or at least one of a list of downlink TCI states, a list of joint TCI states, or a list of uplink TCI states. In aspects, the component 198 may be configured to receive an activation of the TCI for the beam via a MAC-CE that includes a second unified TCI state for at least one of a CORESET, a semi-persistent CSI-RS, a semi-persistent SRS, or an aperiodic SRS, which are configured not to follow the unified TCI indications. In aspects, the component 198 may be configured to receive DCI that indicates at least one of: a joint TCI state for at least one of a PDSCH, a PDCCH, a PUSCH, a PUCCH, a CSI-RS, or a SRS, which are configured to follow the unified TCI indications, a downlink TCI state for at least one of the PDSCH, the PDCCH, or the CSI-RS, which are configured to follow the unified TCI indications, or an uplink TCI state for the PUSCH, the PUCCH, or the SRS, which are configured to follow the unified TCI indications. In aspects, the component 198 may be configured to receive, from the serving cell via the at least one transceiver and RRC signaling, the at least one RACH parameter for the BWP of the set of candidate cells, where the at least one RACH parameter includes at least one of (1) a PRACH parameter or (2) at least one BFR parameter. The component 198 may be further configured to perform any of the aspects described in connection with the flowchart in any of FIGS. 9-12, and/or any of the aspects performed by the UE in any of FIGS. 4, 5, 6, 7, 8. The component 198 may be within the cellular baseband processor 1324, the application processor 1306, or both the cellular baseband processor 1324 and the application processor 1306. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1304 may include a variety of components configured for various functions. In one configuration, the apparatus 1304, and in particular the cellular baseband processor 1324 and/or the application processor 1306, may include means for receiving, from a serving cell, a switching command that indicates a switch associated with L1/L2 mobility of the UE from the serving cell to a candidate cell of a set of candidate cells associated with the L1/L2 mobility of the UE, where the switching command is associated with at least one of (1) a TCJ for a beam or (2) at least one RACH parameter for a BWP of the set of candidate cells. In the configuration, the apparatus 1304, and in particular the cellular baseband processor 1324 and/or the application processor 1306, may include means for communicating with the candidate cell based on the at least one of the TCJ for the beam or the at least one RACH parameter for the BWP. In one configuration, the apparatus 1304, and in particular the cellular baseband processor 1324 and/or the application processor 1306, may include means for receiving, prior to receiving the switching command, at least one of a TCJ configuration for the candidate cell or a RACH configuration for the candidate cell, where the TCJ for the beam is based on the TCJ configuration and the at least one RACH parameter is based on the RACH configuration. In one configuration, the apparatus 1304, and in particular the cellular baseband processor 1324 and/or the application processor 1306, may include means for receiving the TCJ for the beam from the serving cell via RRC signaling and prior to receiving the switching command, where the TC for the beam includes at least one of: a first legacy TCJ state for a periodic CSI-RS, first legacy spatial relation information for a periodic SRS or a PUCCH, or a list of legacy TCJ states for a PDSCH. In one configuration, the apparatus 1304, and in particular the cellular baseband processor 1324 and/or the application processor 1306, may include means for receiving an activation of the TCJ for the beam via a MAC-CE that includes at least one of: a second legacy TCJ state for a CORESET or a semi-persistent CSI-RS, second legacy spatial relation information for at least one of a semi-persistent SRS, an aperiodic SRS, or the PUCCH, a subset of legacy TCJ states for the PDSCH, or a path loss RS for at least one SRS or at least one physical uplink shared channel PUSCH. In one configuration, the apparatus 1304, and in particular the cellular baseband processor 1324 and/or the application processor 1306, may include means for receiving DCI that indicates a third legacy TCI state of the subset of the legacy TCI states for the PDSCH. In one configuration, the apparatus 1304, and in particular the cellular baseband processor 1324 and/or the application processor 1306, may include means for receiving the TCI for the beam from the serving cell via RRC signaling and prior to receiving the switching command, where the TCI for the beam includes at least one of: a first unified TCI state for periodic CSI-RS or a periodic SRS that are configured not to follow unified TCI indications, or at least one of a list of downlink TCI states, a list of joint TCI states, or a list of uplink TCI states. In one configuration, the apparatus 1304, and in particular the cellular baseband processor 1324 and/or the application processor 1306, may include means for receiving an activation of the TCI for the beam via a MAC-CE that includes a second unified TCI state for at least one of a CORESET, a semi-persistent CSI-RS, a semi-persistent SRS, or an aperiodic SRS, which are configured not to follow the unified TCI indications. In aspects, the component 198 may be configured to receive DCI that indicates at least one of: a joint TCI state for at least one of a PDSCH, a PDCCH, a PUSCH, a PUCCH, a CSI-RS, or a SRS, which are configured to follow the unified TCI indications, a downlink TCI state for at least one of the PDSCH, the PDCCH, or the CSI-RS, which are configured to follow the unified TCI indications, or an uplink TCI state for the PUSCH, the PUCCH, or the SRS, which are configured to follow the unified TCI indications. In one configuration, the apparatus 1304, and in particular the cellular baseband processor 1324 and/or the application processor 1306, may include means for receiving, from the serving cell via the at least one transceiver and RRC signaling, the at least one RACH parameter for the BWP of the set of candidate cells, where the at least one RACH parameter includes at least one of (1) a PRACH parameter or (2) at least one BFR parameter. The means may be the component 198 of the apparatus 1304 configured to perform the functions recited by the means. As described supra, the apparatus 1304 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 14 is a diagram 1400 illustrating an example of a hardware implementation for a network entity 1402. The network entity 1402 may be a BS, a component of a BS, or may implement BS functionality. The network entity 1402 may include at least one of a CU 1410, a DU 1430, or an RU 1440. For example, depending on the layer functionality handled by the component 199, the network entity 1402 may include the CU 1410; both the CU 1410 and the DU 1430; each of the CU 1410, the DU 1430, and the RU 1440; the DU 1430; both the DU 1430 and the RU 1440; or the RU 1440. The CU 1410 may include a CU processor 1412. The CU processor 1412 may include on-chip memory 1412′. In some aspects, the CU 1410 may further include additional memory modules 1414 and a communications interface 1418. The CU 1410 communicates with the DU 1430 through a midhaul link, such as an F1 interface. The DU 1430 may include a DU processor 1432. The DU processor 1432 may include on-chip memory 1432′. In some aspects, the DU 1430 may further include additional memory modules 1434 and a communications interface 1438. The DU 1430 communicates with the RU 1440 through a fronthaul link. The RU 1440 may include an RU processor 1442. The RU processor 1442 may include on-chip memory 1442′. In some aspects, the RU 1440 may further include additional memory modules 1444, one or more transceivers 1446, antennas 1480, and a communications interface 1448. The RU 1440 communicates with the UE 104. The on-chip memory 1412′, 1432′, 1442′ and the additional memory modules 1414, 1434, 1444 may each be considered a computer-readable medium/memory. Each computer-readable medium/memory may be non-transitory. Each of the processors 1412, 1432, 1442 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to configure a switching command that indicates a switch associated with L1/L2 mobility for a UE to a candidate cell of a set of candidate cells associated with the L1/L2 mobility of the UE, where the switching command is associated with at least one of (1) a TCI for a beam or (2) at least one RACH parameter for a BWP of the set of candidate cells. The component 199 is also configured to transmit, for the UE, the switching command that indicates the switch associated with the L1/L2 mobility for the UE to the candidate cell. In aspects, the component 199 may be configured to transmit, for the UE and prior to transmitting the switching command, at least one of a TCI configuration for the candidate cell or a RACH configuration for the candidate cell, where the TCI for the beam is based on the TCI configuration and the at least one RACH parameter is based on the RACH configuration. In aspects, the component 199 may be configured to transmit, for the UE via RRC signaling and prior to transmitting the switching command, the TCI for the beam, where the TCI for the beam includes at least one of: a first legacy TCI state for a periodic CSI-RS, first legacy spatial relation information for a periodic SRS or a PUCCH, or a list of legacy TCI states for a PDSCH. In aspects, the component 199 may be configured to transmit, for the UE, an activation of the TCI for the beam via a MAC-CE that includes at least one of: a second legacy TCI state for a CORESET or a semi-persistent CSI-RS, second legacy spatial relation information for at least one of a semi-persistent SRS, an aperiodic SRS, or the PUCCH, a subset of legacy TCI states for the PDSCH, or a path loss RS for at least one SRS or at least one PUSCH. In aspects, the component 199 may be configured to transmit, for the UE, DCI that indicates a third legacy TCI state of the subset of the legacy TCI states for the PDSCH. In aspects, the component 199 may be configured to transmit, for the UE via RRC signaling and prior to receiving the switching command, the TCI for the beam, where the TCI for the beam includes at least one of: a first unified TCI state for periodic CSI-RS or a periodic SRS that are configured not to follow unified TCI indications, or at least one of a list of downlink TCI states, a list of joint TCI states, or a list of uplink TCI states. In aspects, the component 199 may be configured to transmit, for the UE, an activation of the TCI for the beam via a MAC-CE that includes a second unified TCI state for at least one of a CORESET, a semi-persistent CSI-RS, a semi-persistent SRS, or an aperiodic SRS, which are configured not to follow the unified TCI indications. In aspects, the component 199 may be configured to transmit, for the UE, DCI that indicates at least one of: a joint TCI state for at least one of a PDSCH, a PDCCH, a PUSCH, a PUCCH, a CSI-RS, or a SRS, which are configured to follow the unified TCI indications, a downlink TCI state for at least one of the PDSCH, the PDCCH, or the CSI-RS, which are configured to follow the unified TCI indications, or an uplink TCI state for the PUSCH, the PUCCH, or the SRS, which are configured to follow the unified TCI indications. In aspects, the component 199 may be configured to transmit, for the UE via the at least one transceiver and RRC signaling, the at least one RACH parameter for the BWP of the set of candidate cells, where the at least one RACH parameter includes at least one of (1) a PRACH parameter or (2) at least one BFR parameter. The component 199 may be further configured to perform any of the aspects described in connection with the flowchart in any of FIGS. 9-12, and/or any of the aspects performed by a serving cell in any of FIGS. 4, 5, 6, 7, 8. The component 199 may be within one or more processors of one or more of the CU 1410, DU 1430, and the RU 1440. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1402 may include a variety of components configured for various functions. In one configuration, the network entity 1402 may include means for configuring a switching command that indicates a switch associated with L1/L2 mobility for a UE to a candidate cell of a set of candidate cells associated with the L1/L2 mobility of the UE, where the switching command is associated with at least one of (1) a TCI for a beam or (2) at least one RACH parameter for a BWP of the set of candidate cells. In the configuration, the network entity 1402 may include means for transmitting, for the UE, the switching command that indicates the switch associated with the L1/L2 mobility for the UE to the candidate cell. In one configuration, the network entity 1402 may include means for transmitting, for the UE and prior to transmitting the switching command, at least one of a TCI configuration for the candidate cell or a RACH configuration for the candidate cell, where the TCI for the beam is based on the TCI configuration and the at least one RACH parameter is based on the RACH configuration. In the configuration, the network entity 1402 may include means for transmitting, for the UE via RRC signaling and prior to transmitting the switching command, the TCI for the beam, where the TCI for the beam includes at least one of: a first legacy TCI state for a periodic CSI-RS, first legacy spatial relation information for a periodic SRS or a PUCCH, or a list of legacy TCI states for a PDSCH. In the configuration, the network entity 1402 may include means for transmitting, for the UE, an activation of the TCI for the beam via a MAC-CE that includes at least one of: a second legacy TCI state for a CORESET or a semi-persistent CSI-RS, second legacy spatial relation information for at least one of a semi-persistent SRS, an aperiodic SRS, or the PUCCH, a subset of legacy TCI states for the PDSCH, or a path loss RS for at least one SRS or at least one PUSCH. In the configuration, the network entity 1402 may include means for transmitting, for the UE, DCI that indicates a third legacy TCI state of the subset of the legacy TCI states for the PDSCH. In the configuration, the network entity 1402 may include means for transmitting, for the UE via RRC signaling and prior to receiving the switching command, the TCI for the beam, where the TCI for the beam includes at least one of: a first unified TCI state for periodic CSI-RS or a periodic SRS that are configured not to follow unified TCI indications, or at least one of a list of downlink TCI states, a list of joint TCI states, or a list of uplink TCI states. In the configuration, the network entity 1402 may include means for transmitting, for the UE, an activation of the TCI for the beam via a MAC-CE that includes a second unified TCI state for at least one of a CORESET, a semi-persistent CSI-RS, a semi-persistent SRS, or an aperiodic SRS, which are configured not to follow the unified TCI indications. In the configuration, the network entity 1402 may include means for transmitting, for the UE, DCI that indicates at least one of: a joint TCI state for at least one of a PDSCH, a PDCCH, a PUSCH, a PUCCH, a CSI-RS, or a SRS, which are configured to follow the unified TCI indications, a downlink TCI state for at least one of the PDSCH, the PDCCH, or the CSI-RS, which are configured to follow the unified TCI indications, or an uplink TCI state for the PUSCH, the PUCCH, or the SRS, which are configured to follow the unified TCI indications. In the configuration, the network entity 1402 may include means for transmitting, for the UE via the at least one transceiver and RRC signaling, the at least one RACH parameter for the BWP of the set of candidate cells, where the at least one RACH parameter includes at least one of (1) a PRACH parameter or (2) at least one BFR parameter. The means may be the component 199 of the network entity 1402 configured to perform the functions recited by the means. As described supra, the network entity 1402 may include the TX processor 316, the RX processor 370, and the controller/processor 375. As such, in one configuration, the means may be the TX processor 316, the RX processor 370, and/or the controller/processor 375 configured to perform the functions recited by the means.

FIG. 15 is a diagram 1500 illustrating an example of a hardware implementation for a network entity 1560. In one example, the network entity 1560 may be within the core network 120. The network entity 1560 may include a network processor 1512. The network processor 1512 may include on-chip memory 1512′. In some aspects, the network entity 1560 may further include additional memory modules 1514. The network entity 1560 communicates via the network interface 1580 directly (e.g., backhaul link) or indirectly (e.g., through a RIC) with the CU 1502. The on-chip memory 1512′ and the additional memory modules 1514 may each be considered a computer-readable medium/memory. Each computer-readable medium/memory may be non-transitory. The processor 1512 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to configure a switching command that indicates a switch associated with L1/L2 mobility for a UE to a candidate cell of a set of candidate cells associated with the L1/L2 mobility of the UE, where the switching command is associated with at least one of (1) a TCI for a beam or (2) at least one RACH parameter for a BWP of the set of candidate cells. The component 199 is also configured to transmit, for the UE, the switching command that indicates the switch associated with the L1/L2 mobility for the UE to the candidate cell. In aspects, the component 199 may be configured to transmit, for the UE and prior to transmitting the switching command, at least one of a TCI configuration for the candidate cell or a RACH configuration for the candidate cell, where the TCI for the beam is based on the TCI configuration and the at least one RACH parameter is based on the RACH configuration. In aspects, the component 199 may be configured to transmit, for the UE via RRC signaling and prior to transmitting the switching command, the TCI for the beam, where the TCI for the beam includes at least one of: a first legacy TCI state for a periodic CSI-RS, first legacy spatial relation information for a periodic SRS or a PUCCH, or a list of legacy TCI states for a PDSCH. In aspects, the component 199 may be configured to transmit, for the UE, an activation of the TCI for the beam via a MAC-CE that includes at least one of: a second legacy TCI state for a CORESET or a semi-persistent CSI-RS, second legacy spatial relation information for at least one of a semi-persistent SRS, an aperiodic SRS, or the PUCCH, a subset of legacy TCI states for the PDSCH, or a path loss RS for at least one SRS or at least one PUSCH. In aspects, the component 199 may be configured to transmit, for the UE, DCI that indicates a third legacy TCI state of the subset of the legacy TCI states for the PDSCH. In aspects, the component 199 may be configured to transmit, for the UE via RRC signaling and prior to receiving the switching command, the TCI for the beam, where the TCI for the beam includes at least one of: a first unified TCI state for periodic CSI-RS or a periodic SRS that are configured not to follow unified TCI indications, or at least one of a list of downlink TCI states, a list of joint TCI states, or a list of uplink TCI states. In aspects, the component 199 may be configured to transmit, for the UE, an activation of the TCI for the beam via a MAC-CE that includes a second unified TCI state for at least one of a CORESET, a semi-persistent CSI-RS, a semi-persistent SRS, or an aperiodic SRS, which are configured not to follow the unified TCI indications. In aspects, the component 199 may be configured to transmit, for the UE, DCI that indicates at least one of: a joint TCI state for at least one of a PDSCH, a PDCCH, a PUSCH, a PUCCH, a CSI-RS, or a SRS, which are configured to follow the unified TCI indications, a downlink TCI state for at least one of the PDSCH, the PDCCH, or the CSI-RS, which are configured to follow the unified TCI indications, or an uplink TCI state for the PUSCH, the PUCCH, or the SRS, which are configured to follow the unified TCI indications. In aspects, the component 199 may be configured to transmit, for the UE via the at least one transceiver and RRC signaling, the at least one RACH parameter for the BWP of the set of candidate cells, where the at least one RACH parameter includes at least one of (1) a PRACH parameter or (2) at least one BFR parameter. The component 199 may be further configured to perform any of the aspects described in connection with the flowchart in any of FIGS. 9-12, and/or any of the aspects performed by a serving cell in any of FIGS. 4, 5, 6, 7, 8. The component 199 may be within the processor 1512. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1560 may include a variety of components configured for various functions. In one configuration, the network entity 1560 may include means for configuring a switching command that indicates a switch associated with L1/L2 mobility for a UE to a candidate cell of a set of candidate cells associated with the L1/L2 mobility of the UE, where the switching command is associated with at least one of (1) a TCI for a beam or (2) at least one RACH parameter for a BWP of the set of candidate cells. In the configuration, the network entity 1560 may include means for transmitting, for the UE, the switching command that indicates the switch associated with the L1/L2 mobility for the UE to the candidate cell. In one configuration, the network entity 1560 may include means for transmitting, for the UE and prior to transmitting the switching command, at least one of a TCI configuration for the candidate cell or a RACH configuration for the candidate cell, where the TCI for the beam is based on the TCI configuration and the at least one RACH parameter is based on the RACH configuration. In one configuration, the network entity 1560 may include means for transmitting, for the UE via RRC signaling and prior to transmitting the switching command, the TCI for the beam, where the TCI for the beam includes at least one of: a first legacy TCI state for a periodic CSI-RS, first legacy spatial relation information for a periodic SRS or a PUCCH, or a list of legacy TCI states for a PDSCH. In one configuration, the network entity 1560 may include means for transmitting, for the UE, an activation of the TCI for the beam via a MAC-CE that includes at least one of: a second legacy TCI state for a CORESET or a semi-persistent CSI-RS, second legacy spatial relation information for at least one of a semi-persistent SRS, an aperiodic SRS, or the PUCCH, a subset of legacy TCI states for the PDSCH, or a path loss RS for at least one SRS or at least one PUSCH. In one configuration, the network entity 1560 may include means for transmitting, for the UE, DCI that indicates a third legacy TCI state of the subset of the legacy TCI states for the PDSCH. In one configuration, the network entity 1560 may include means for transmitting, for the UE via RRC signaling and prior to receiving the switching command, the TCI for the beam, where the TCI for the beam includes at least one of: a first unified TCI state for periodic CSI-RS or a periodic SRS that are configured not to follow unified TCI indications, or at least one of a list of downlink TCI states, a list of joint TCI states, or a list of uplink TCI states. In one configuration, the network entity 1560 may include means for transmitting, for the UE, an activation of the TCI for the beam via a MAC-CE that includes a second unified TCI state for at least one of a CORESET, a semi-persistent CSI-RS, a semi-persistent SRS, or an aperiodic SRS, which are configured not to follow the unified TCI indications. In one configuration, the network entity 1560 may include means for transmitting, for the UE, DCI that indicates at least one of: a joint TCI state for at least one of a PDSCH, a PDCCH, a PUSCH, a PUCCH, a CSI-RS, or a SRS, which are configured to follow the unified TCI indications, a downlink TCI state for at least one of the PDSCH, the PDCCH, or the CSI-RS, which are configured to follow the unified TCI indications, or an uplink TCI state for the PUSCH, the PUCCH, or the SRS, which are configured to follow the unified TCI indications. In one configuration, the network entity 1560 may include means for transmitting, for the UE via the at least one transceiver and RRC signaling, the at least one RACH parameter for the BWP of the set of candidate cells, where the at least one RACH parameter includes at least one of (1) a PRACH parameter or (2) at least one BFR parameter. The means may be the component 199 of the network entity 1560 configured to perform the functions recited by the means.

Wireless communication networks, such as an LTE network and/or a 5G NR network, may be designed for UE mobility. Such UE mobility may be layer-3 mobility that relies on relatively slow messaging and configuration of UEs for post-mobility communications. As an example, a UE may be initially served by a serving cell, which may include a 5G NR cell or “SCell,” a combination of 5G NR and legacy protocols and/or hardware (e.g., an “SpCell” implementation), while candidate cells (e.g., legacy cells, 5G NR cells, and/or the like) are available to the UE for L3 mobility. The UE may receive L3 mobility communications from the serving cell for a move via L3 mobility to one of the candidate cells as a new serving cell, and the UE then moves to the new serving cell and initiates its setup for communications therewith (e.g., configurations for beams, a transmission configuration indication (TCI), a random access channel (RACH), etc.).

However, as noted above, L3 mobility may be relatively slow, and may not enable pre-configurations for various communications associated with candidate cells for mobility. The aspects described herein provide for L1/L2 mobility of UEs that includes beam and RACH pre-configurations for candidate cells, which may be faster and more efficient than L3 mobility. For example, a UE may receive, from a serving cell, a switching command that indicates a switch associated with L1/L2 mobility of the UE from the serving cell to a candidate cell of a set of candidate cells. The switching command may be associated with a TCI for a beam and/or a RACH parameter(s) for a BWP of the set of candidate cells. The UE may thus be pre-configured to communicate with the candidate cell, via L1/L2 mobility, based on the TCI for the beam and/or the RACH parameter(s) for the BWP, which may reduce mobility latency.

Various aspects relate generally to inter-cell mobility of UEs. Some aspects more specifically relate to L1/L2 inter-cell mobility of UEs with pre-configurations for beams and RACHs of candidate cells. In some examples, beams may be pre-configured by a serving cell via RRC signaling, a MAC-CE, and DCI, and/or via a switching command itself, while a RACH may be pre-configured through a RACH parameter(s) for a BWP of candidate cells via RRC signaling, including beam failure recovery configurations.

Particular aspects of the subject matter described in this disclosure can be implemented to realize one or more of the following potential advantages. In some examples, by pre-configuring beams and RACHs for candidate cells in L1/L2 mobility, the described techniques can be used to reduce mobility latency through fast application of configurations for candidate cells, dynamic switching mechanisms among candidate cells, L1 enhancements for inter-cell beam management, including L1 measurement and reporting, and beam indication, inter-frequency and intra-frequency scenarios, etc.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, including: receiving, from a serving cell, a switching command that indicates a switch associated with a layer-1 or layer-2 (L1/L2) mobility of the UE from the serving cell to a candidate cell of a set of candidate cells associated with the L1/L2 mobility of the UE, where the switching command is associated with at least one of (1) a transmission configuration indication (TCI) for a beam or (2) at least one random access channel (RACH) parameter for a bandwidth part (BWP) of the set of candidate cells; and communicating with the candidate cell based on the at least one of the TCI for the beam or the at least one RACH parameter for the BWP.

Aspect 2 is the method of aspect 1, further including: receiving, prior to receiving the switching command, at least one of a TCI configuration for the candidate cell or a RACH configuration for the candidate cell, where the TCI for the beam is based on the TCI configuration and the at least one RACH parameter is based on the RACH configuration.

Aspect 3 is the method of any of aspects 1 and 2, further including: receiving the TCI for the beam from the serving cell via radio resource control (RRC) signaling and prior to receiving the switching command, where the TCI for the beam includes at least one of: a first legacy TCI state for a periodic channel signal information (CSI) reference signal (CSI-RS), first legacy spatial relation information for a periodic sounding reference signal (SRS) or a physical uplink control channel (PUCCH), or a list of legacy TCI states for a physical downlink shared channel (PDSCH).

Aspect 4 is the method of aspect 3, further including: receiving an activation of the TCI for the beam via a medium access control (MAC) control element (MAC-CE) that includes at least one of: a second legacy TCI state for a control resource set (CORESET) or a semi-persistent CSI-RS, second legacy spatial relation information for at least one of a semi-persistent SRS, an aperiodic SRS, or the PUCCH, a subset of legacy TCI states for the PDSCH, or a path loss RS for at least one SRS or at least one physical uplink shared channel (PUSCH).

Aspect 5 is the method of aspect 4, further including: receiving downlink control information (DCI) that indicates a third legacy TCI state of the subset of the legacy TCI states for the PDSCH.

Aspect 6 is the method of any of aspects 1 and 2, further including: receiving the TCI for the beam from the serving cell via radio resource control (RRC) signaling and prior to receiving the switching command, where the TCI for the beam includes at least one of: a first unified TCI state for periodic channel signal information (CSI) reference signal (CSI-RS) or a periodic sounding reference signal (SRS) that are configured not to follow unified TCI indications, or at least one of a list of downlink TCI states, a list of joint TCI states, or a list of uplink TCI states.

Aspect 7 is the method of aspect 6, further including: receiving an activation of the TCI for the beam via a medium access control (MAC) control element (MAC-CE) that includes a second unified TCI state for at least one of a control resource set (CORESET), a semi-persistent CSI-RS, a semi-persistent SRS, or an aperiodic SRS, which are configured not to follow the unified TCI indications.

Aspect 8 is the method of aspect 7, further including: receiving downlink control information (DCI) that indicates at least one of: a joint TCI state for at least one of a physical downlink shared channel (PDSCH), a physical downlink control channel (PDCCH), a physical uplink shared channel (PUSCH), a physical uplink control channel (PUCCH), a CSI-RS, or a SRS, which are configured to follow the unified TCI indications, a downlink TCI state for at least one of the PDSCH, the PDCCH, or the CSI-RS, which are configured to follow the unified TCI indications, or an uplink TCI state for the PUSCH, the PUCCH, or the SRS, which are configured to follow the unified TCI indications.

Aspect 9 is the method of any of aspects 1 and 2, where the switching command includes the TCI for the beam.

Aspect 10 is the method of aspect 9, where the TCI for the beam includes at least one of: a first legacy TCI state for a periodic channel signal information (CSI) reference signal (CSI-RS), first legacy spatial relation information for a periodic sounding reference signal (SRS) or a physical uplink control channel (PUCCH), a second legacy TCI state for a control resource set (CORESET) or a semi-persistent CSI-RS, second legacy spatial relation information for at least one of a semi-persistent SRS, an aperiodic SRS, or the PUCCH, a path loss RS for at least one of a SRS or a physical uplink shared channel (PUSCH), or a third legacy TCI state for a physical downlink shared channel (PDSCH).

Aspect 11 is the method of aspect 10, where the switching command includes at least one of: a medium access control (MAC) control element (MAC-CE) that activates the TCI for the beam, or downlink control information (DCI) that indicates the TCI for the beam.

Aspect 12 is the method of any of aspects 9 to 11, where the TCI for the beam includes at least one of: a unified TCI associated with one or more channels and RSs; or a first unified TCI associated with a first set of the one or more channels and the RSs, which is configured to follow unified TCI indications, and a second unified TCI associated with a second set of the one or more channels and the RSs, which is not configured to follow the unified TCI indications.

Aspect 13 is the method of any of aspects 1 and 2, further including: receiving, from the serving cell via at least one transceiver of the UE and via radio resource control (RRC) signaling, the at least one RACH parameter for the BWP of the set of candidate cells, where the at least one RACH parameter includes at least one of (1) a physical RACH (PRACH) parameter or (2) at least one beam failure recovery (BFR) parameter.

Aspect 14 is the method of aspect 13, where the PRACH parameter includes at least one of: a number of PRACH transmission occasions in a time instance based on frequency domain multiplexing (FDM), an offset of a lowest PRACH transmission occasion in a frequency domain with respect to an initial physical resource block (PRB), a maximum number of random access preamble transmissions performed before a failure is declared, power ramping steps for at PRACH, or a Message 2 random access response window length in a number of slots; where the at least one RACH parameter for the BWP further includes at least one of: a total number of PRACH preambles, a number of synchronized signal blocks (SSBs) per RACH occasion, a SSB threshold, for selecting the PRACH, that is associated with SSB selection and a corresponding PRACH resource selection for path-loss estimation and transmission or retransmission operations, an initial value for a PRACH contention resolution timer, a root sequence for the PRACH, a subcarrier spacing for the PRACH, a first configuration of an unrestricted set, a second configuration of at least one type of restricted set, or a transform precoder indication for a Message 3 transmission.

Aspect 15 is the method of any of aspects 13 and 14, where the at least one BFR parameter includes at least one of: a BFR PRACH parameter, a root sequence for PRACH-based BFR, a candidate beam threshold, a candidate beam list, a number of synchronized signal blocks (SSBs) per RACH occasion for the PRACH-based BFR, a mask for PRACH-based BFR transmission, a BFR search space identifier for the PRACH-based BFR, or a BFR timer for the PRACH-based BFR.

Aspect 16 is the method of wireless communications at a serving cell, including: configuring a switching command that indicates a switch associated with a layer-1 or layer-2 (L1/L2) mobility for a user equipment (UE) to a candidate cell of a set of candidate cells associated with the L1/L2 mobility of the UE, where the switching command is associated with at least one of (1) a transmission configuration indication (TCI) for a beam or (2) at least one random access channel (RACH) parameter for a bandwidth part (BWP) of the set of candidate cells; and transmitting, for the UE, the switching command that indicates the switch associated with the L1/L2 mobility for the UE to the candidate cell.

Aspect 17 is the method of aspect 16, further including: transmitting, for the UE and prior to transmitting the switching command, at least one of a TCI configuration for the candidate cell or a RACH configuration for the candidate cell, where the TCI for the beam is based on the TCI configuration and the at least one RACH parameter is based on the RACH configuration.

Aspect 18 is the method of any of aspects 16 and 17, further including: transmitting, for the UE via radio resource control (RRC) signaling and prior to transmitting the switching command, the TCI for the beam, where the TCI for the beam includes at least one of: a first legacy TCI state for a periodic channel signal information (CSI) reference signal (CSI-RS), first legacy spatial relation information for a periodic sounding reference signal (SRS) or a physical uplink control channel (PUCCH), or a list of legacy TCI states for a physical downlink shared channel (PDSCH).

Aspect 19 is the method of aspect 18, further including: transmitting, for the UE, an activation of the TCI for the beam via a medium access control (MAC) control element (MAC-CE) that includes at least one of: a second legacy TCI state for a control resource set (CORESET) or a semi-persistent CSI-RS, second legacy spatial relation information for at least one of a semi-persistent SRS, an aperiodic SRS, or the PUCCH, a subset of legacy TCI states for the PDSCH, or a path loss RS for at least one SRS or at least one physical uplink shared channel (PUSCH).

Aspect 20 is the method of aspect 19, further including: transmitting, for the UE, downlink control information (DCI) that indicates a third legacy TCI state of the subset of the legacy TCI states for the PDSCH.

Aspect 21 is the method of any of aspects 16 and 17, further including: transmitting, for the UE via radio resource control (RRC) signaling and prior to receiving the switching command, the TCI for the beam, where the TCI for the beam includes at least one of: a first unified TCI state for periodic channel signal information (CSI) reference signal (CSI-RS) or a periodic sounding reference signal (SRS) that are configured not to follow unified TCI indications, or at least one of a list of downlink TCI states, a list of joint TCI states, or a list of uplink TCI states.

Aspect 22 is the method of aspect 21, further including: transmitting, for the UE, an activation of the TCJ for the beam via a medium access control (MAC) control element (MAC-CE) that includes a second unified TCJ state for at least one of a control resource set (CORESET), a semi-persistent CSI-RS, a semi-persistent SRS, or an aperiodic SRS, which are configured not to follow the unified TCJ indications.

Aspect 23 is the method of aspect 22, further including: transmitting, for the UE, downlink control information (DCI) that indicates at least one of: a joint TCJ state for at least one of a physical downlink shared channel (PDSCH), a physical downlink control channel (PDCCH), a physical uplink shared channel (PUSCH), a physical uplink control channel (PUCCH), a CSI-RS, or a SRS, which are configured to follow the unified TCJ indications, a downlink TCJ state for at least one of the PDSCH, the PDCCH, or the CSI-RS, which are configured to follow the unified TCJ indications, or an uplink TCJ state for the PUSCH, the PUCCH, or the SRS, which are configured to follow the unified TCJ indications.

Aspect 24 is the method of any of aspects 16 and 17, where the switching command includes the TCJ for the beam, and where the TCJ for the beam includes at least one of: a first legacy TCJ state for a periodic channel signal information (CSI) reference signal (CSI-RS), first legacy spatial relation information for a periodic sounding reference signal (SRS) or a physical uplink control channel (PUCCH), a second legacy TCJ state for a control resource set (CORESET) or a semi-persistent CSI-RS, second legacy spatial relation information for at least one of a semi-persistent SRS, an aperiodic SRS, or the PUCCH, a path loss RS for at least one of a SRS or a physical uplink shared channel (PUSCH), or a third legacy TCJ state for a physical downlink shared channel (PDSCH).

Aspect 25 is the method of aspect 24, where the switching command includes the TCJ for the beam, where the switching command includes at least one of: a medium access control (MAC) control element (MAC-CE) that activates the TCJ for the beam, or downlink control information (DCI) that indicates the TCJ for the beam.

Aspect 26 is the method of aspect 24, where the TCJ for the beam includes at least one of: a unified TCJ associated with one or more channels and RSs; or a first unified TCJ associated with a first set of the one or more channels and the RSs, which is configured to follow unified TCJ indications, and a second unified TCJ associated with a second set of the one or more channels and the RSs, which is not configured to follow the unified TCJ indications.

Aspect 27 is the method of any of aspects 16 and 17, further including: transmitting, for the UE via at least one transceiver of the serving cell and via radio resource control (RRC) signaling, the at least one RACH parameter for the BWP of the set of candidate cells, v the at least one RACH parameter includes at least one of (1) a physical RACH (PRACH) parameter or (2) at least one beam failure recovery (BFR) parameter.

Aspect 28 is the method of aspect 27, where the PRACH parameter includes at least one of: a number of PRACH transmission occasions in a time instance based on frequency domain multiplexing (FDM), an offset of a lowest PRACH transmission occasion in a frequency domain with respect to an initial physical resource block (PRB), a maximum number of random access preamble transmissions performed before a failure is declared, power ramping steps for at PRACH, or a Message 2 random access response window length in a number of slots; where the at least one RACH parameter for the BWP further includes at least one of: a total number of PRACH preambles, a first number of synchronized signal blocks (SSBs) per RACH occasion, a SSB threshold, for selecting the PRACH, that is associated with SSB selection and a corresponding PRACH resource selection for path-loss estimation and transmission or retransmission operations, an initial value for a PRACH contention resolution timer, a first root sequence for the PRACH, a subcarrier spacing for the PRACH, a first configuration of an unrestricted set, a second configuration of at least one type of restricted set, or a transform precoder indication for a Message 3 transmission; where the at least one BFR parameter includes at least one of: a BFR PRACH parameter, a second root sequence for PRACH-based BFR, a candidate beam threshold, a candidate beam list, a second number of SSBs per the RACH occasion for the PRACH-based BFR, a mask for PRACH-based BFR transmission, a BFR search space identifier for the PRACH-based BFR, or a BFR timer for the PRACH-based BFR.

Aspect 29 is an apparatus for wireless communication including means for implementing any of aspects 1 to 15.

Aspect 30 is a computer-readable medium (e.g., a non-transitory computer-readable medium) storing computer executable code, the code when executed by at least one processor causes the at least one processor to implement any of aspects 1 to 15.

Aspect 31 is an apparatus for wireless communication at a network node. The apparatus includes a memory; and at least one processor coupled to the memory and, based at least in part on information stored in the memory, the at least one processor is configured to implement any of aspects 1 to 15.

Aspect 32 is the apparatus of aspect 31, further including at least one of a transceiver or an antenna coupled to the at least one processor.

Aspect 33 is an apparatus for wireless communication including means for implementing any of aspects 16 to 28.

Aspect 34 is a computer-readable medium (e.g., a non-transitory computer-readable medium) storing computer executable code, the code when executed by at least one processor causes the at least one processor to implement any of aspects 16 to 28.

Aspect 35 is an apparatus for wireless communication at a network node. The apparatus includes a memory; and at least one processor coupled to the memory and, based at least in part on information stored in the memory, the at least one processor is configured to implement any of aspects 16 to 28.

Aspect 36 is the apparatus of aspect 35, further including at least one of a transceiver or an antenna coupled to the at least one processor.

1. An apparatus for wireless communications at a user equipment (UE), comprising:
a memory; and
at least one processor coupled to the memory and, based at least in part on information stored in the memory, the at least one processor is configured to:
receive, from a serving cell, a switching command that indicates a switch associated with a layer-1 or layer-2 (L1/L2) mobility of the UE from the serving cell to a candidate cell of a set of candidate cells associated with the L1/L2 mobility of the UE, wherein the switching command is associated with at least one of (1) a transmission configuration indication (TCI) for a beam or (2) at least one random access channel (RACH) parameter for a bandwidth part (BWP) of the set of candidate cells; and
communicate with the candidate cell based on the at least one of the TCI for the beam or the at least one RACH parameter for the BWP.

2. The apparatus of claim 1, wherein the at least one processor is further configured to:
receive, prior to receiving the switching command, at least one of a TCI configuration for the candidate cell or a RACH configuration for the candidate cell, wherein the TCI for the beam is based on the TCI configuration and the at least one RACH parameter is based on the RACH configuration.

3. The apparatus of claim 1, wherein the at least one processor is further configured to:
receive, prior to receiving the switching command, the TCI for the beam from the serving cell via radio resource control (RRC) signaling, wherein the TCI for the beam includes at least one of:
a first legacy TCI state for a periodic channel signal information (CSI) reference signal (CSI-RS),
first legacy spatial relation information for a periodic sounding reference signal (SRS) or a physical uplink control channel (PUCCH), or
a list of legacy TCI states for a physical downlink shared channel (PDSCH).

4. The apparatus of claim 3, wherein the at least one processor is further configured to:
receive an activation of the TCI for the beam via a medium access control (MAC) control element (MAC-CE) that includes at least one of:
a second legacy TCI state for a control resource set (CORESET) or a semi-persistent CSI-RS,
second legacy spatial relation information for at least one of a semi-persistent SRS, an aperiodic SRS, or the PUCCH,
a subset of legacy TCI states for the PDSCH, or
a path loss RS for at least one SRS or at least one physical uplink shared channel (PUSCH).

5. The apparatus of claim 4, wherein the at least one processor is further configured to:
receive downlink control information (DCI) that indicates a third legacy TCI state of the subset of the legacy TCI states for the PDSCH.

6. The apparatus of claim 1, wherein the at least one processor is further configured to:
receive, prior to receiving the switching command, the TCI for the beam from the serving cell via radio resource control (RRC) signaling, wherein the TCI for the beam includes at least one of:
a first unified TCI state for periodic channel signal information (CSI) reference signal (CSI-RS) or a periodic sounding reference signal (SRS) that are configured not to follow unified TCI indications, or
at least one of a list of downlink TCI states, a list of joint TCI states, or a list of uplink TCI states.

7. The apparatus of claim 6, wherein the at least one processor is further configured to:
receive an activation of the TCI for the beam via a medium access control (MAC) control element (MAC-CE) that includes a second unified TCI state for at least one of a control resource set (CORESET), a semi-persistent CSI-RS, a semi-persistent SRS, or an aperiodic SRS, which are configured not to follow the unified TCI indications.

8. The apparatus of claim 7, wherein the at least one processor is further configured to:
receive downlink control information (DCI) that indicates at least one of:
a joint TCI state for at least one of a physical downlink shared channel (PDSCH), a physical downlink control channel (PDCCH), a physical uplink shared channel (PUSCH), a physical uplink control channel (PUCCH), a CSI-RS, or a SRS, which are configured to follow the unified TCI indications,
a downlink TCI state for at least one of the PDSCH, the PDCCH, or the CSI-RS, which are configured to follow the unified TCI indications, or
an uplink TCI state for the PUSCH, the PUCCH, or the SRS, which are configured to follow the unified TCI indications.

9. The apparatus of claim 1, wherein the switching command includes the TCI for the beam.

10. The apparatus of claim 9, wherein the TCI for the beam includes at least one of:
a first legacy TCI state for a periodic channel signal information (CSI) reference signal (CSI-RS),
first legacy spatial relation information for a periodic sounding reference signal (SRS) or a physical uplink control channel (PUCCH),
a second legacy TCI state for a control resource set (CORESET) or a semi-persistent CSI-RS,
second legacy spatial relation information for at least one of a semi-persistent SRS, an aperiodic SRS, or the PUCCH,
a path loss RS for at least one of a SRS or a physical uplink shared channel (PUSCH), or
a third legacy TCI state for a physical downlink shared channel (PDSCH).

11. The apparatus of claim 10, wherein the switching command includes at least one of:
a medium access control (MAC) control element (MAC-CE) that activates the TCI for the beam, or
downlink control information (DCI) that indicates the TCI for the beam.

12. The apparatus of claim 9, wherein the TCI for the beam includes at least one of:
a unified TCI associated with one or more channels and RSs; or
a first unified TCI associated with a first set of the one or more channels and the RSs, which is configured to follow unified TCI indications, and a second unified TCI associated with a second set of the one or more channels and the RSs, which is not configured to follow the unified TCI indications.

13. The apparatus of claim 1, further comprising at least one transceiver coupled to the at least one processor, wherein the at least one processor is further configured to:
receive, from the serving cell via the at least one transceiver and via radio resource control (RRC) signaling, the at least one RACH parameter for the BWP of the set of candidate cells, wherein the at least one RACH parameter includes at least one of (1) a physical RACH (PRACH) parameter or (2) at least one beam failure recovery (BFR) parameter.

14. The apparatus of claim 13, wherein the PRACH parameter includes at least one of:
a number of PRACH transmission occasions in a time instance based on frequency domain multiplexing (FDM),
an offset of a lowest PRACH transmission occasion in a frequency domain with respect to an initial physical resource block (PRB),
a maximum number of random access preamble transmissions performed before a failure is declared,
power ramping steps for at PRACH, or
a Message 2 random access response window length in a number of slots; wherein the at least one RACH parameter for the BWP further includes at least one of:
a total number of PRACH preambles,
a number of synchronized signal blocks (SSBs) per RACH occasion,
a SSB threshold, for selecting the PRACH, that is associated with SSB selection and a corresponding PRACH resource selection for path-loss estimation and transmission or retransmission operations,
an initial value for a PRACH contention resolution timer,
a root sequence for the PRACH,
a subcarrier spacing for the PRACH,
a first configuration of an unrestricted set,
a second configuration of at least one type of restricted set, or
a transform precoder indication for a Message 3 transmission.

15. The apparatus of claim 13, wherein the at least one BFR parameter includes at least one of:
a BFR PRACH parameter,
a root sequence for PRACH-based BFR,
a candidate beam threshold,
a candidate beam list,
a number of synchronized signal blocks (SSBs) per RACH occasion for the PRACH-based BFR,
a mask for PRACH-based BFR transmission,
a BFR search space identifier for the PRACH-based BFR, or
a BFR timer for the PRACH-based BFR.

16. An apparatus for wireless communications at a serving cell, comprising:
a memory; and
at least one processor coupled to the memory and, based at least in part on information stored in the memory, the at least one processor is configured to:
configure a switching command that indicates a switch associated with a layer-1 or layer-2 (L1/L2) mobility for a user equipment (UE) to a candidate cell of a set of candidate cells associated with the L1/L2 mobility of the UE, wherein the switching command is associated with at least one of (1) a transmission configuration indication (TCI) for a beam or (2) at least one random access channel (RACH) parameter for a bandwidth part (BWP) of the set of candidate cells; and
transmit, for the UE, the switching command that indicates the switch associated with the L1/L2 mobility for the UE to the candidate cell.

17. The apparatus of claim 16, wherein the at least one processor is further configured to:
transmit, for the UE and prior to transmitting the switching command, at least one of a TCI configuration for the candidate cell or a RACH configuration for the candidate cell, wherein the TCI for the beam is based on the TCI configuration and the at least one RACH parameter is based on the RACH configuration.

18. The apparatus of claim 16, wherein the at least one processor is further configured to:
transmit, for the UE via radio resource control (RRC) signaling and prior to transmitting the switching command, the TCI for the beam, wherein the TCI for the beam includes at least one of:
a first legacy TCI state for a periodic channel signal information (CSI) reference signal (CSI-RS),
first legacy spatial relation information for a periodic sounding reference signal (SRS) or a physical uplink control channel (PUCCH), or
a list of legacy TCI states for a physical downlink shared channel (PDSCH).

19. The apparatus of claim 18, wherein the at least one processor is further configured to:
transmit, for the UE, an activation of the TCI for the beam via a medium access control (MAC) control element (MAC-CE) that includes at least one of:
a second legacy TCI state for a control resource set (CORESET) or a semi-persistent CSI-RS,
second legacy spatial relation information for at least one of a semi-persistent SRS, an aperiodic SRS, or the PUCCH,
a subset of legacy TCI states for the PDSCH, or
a path loss RS for at least one SRS or at least one physical uplink shared channel (PUSCH).

20-28. (canceled)

29. A method of wireless communications at a user equipment (UE), comprising:
receiving, from a serving cell, a switching command that indicates a switch associated with a layer-1 or layer-2 (L1/L2) mobility of the UE from the serving cell to a candidate cell of a set of candidate cells associated with the L1/L2 mobility of the UE, wherein the switching command is associated with at least one of (1) a transmission configuration indication (TCI) for a beam or (2) at least one random access channel (RACH) parameter for a bandwidth part (BWP) of the set of candidate cells; and
communicating with the candidate cell based on the at least one of the TCI for the beam or the at least one RACH parameter for the BWP.

30. (canceled)
